(19) United States
(12) Patent Application Publication
(10) Pub. No.: US 2003/0188627 A1
(43) Pub. Date: Oct. 9, 2003

(54) Interactive performance interface for electronic sound device

(76) Inventor: Nicholas C. Longo, Berkeley, CA (US)

Correspondence Address: Nicholas Longo, 2315 Grant St., #2, Berkeley, CA, 94203, US

(21) Appl. No.: 10/117,239

(22) Filed: Apr. 5, 2002

(51) Int. Cl. G10H 1/057

(52) U.S. Cl. 84/627

(57) ABSTRACT

An Interactive Performance Interface for use with an audio system uses at least one performance mode to provide access to control rate and audio rate signals activated by interaction rate signals synthesized by interactive control envelopes. Audio signals, control rate signals, interactive envelopes and performance modes are all selectable and may be user-activated with user controls that change function according to a hierarchy of conditional latches.

### FIELD OF THE INVENTION

The present invention relates generally to the field of electronic musical instruments and to the problem of user interaction with electronic sound production devices. It may be implemented as an interactive audio system or provide a performance layer for existing audio systems and may include the Gesture synthesis methods disclosed in U.S. Pat. No. 6,066,794 to Longo (2000) and pending Reissue patent application Ser. No. 09/594,741 of which all parts of both are incorporated herein by reference.

### BACKGROUND OF THE INVENTION

Many kinds of interfaces have been designed to allow a user to interact with sound production circuitry. Some are mechanical devices built to resemble traditional musical instruments such as a guitar or saxophone. Others are unique to electronic instruments, and have all manner of fanciful constructions. Since electronic music synthesizers produce sound in response to electronic control signals, user interfaces include circuitry to generate electronic signals in response to user actions. These signals include discrete events and continuously varying streams of data.

The continuous data is referred to as “control rate data”. Control rate data, is commonly generated in response to user operation of devices such as wheels and joysticks. For the purposes of the present invention a control rate signal is a stream of control rate data that has a period that is below that which may be perceived as an audio tone. The period of a control rate signal may be determined by either the zero crossing points of a repeating waveform, or the start and stop points of control rate data representing a user gesture, such as the endpoints of a single movement of a control operator. Thus control rate signals operate in the same general range as human gestures.

The sample rate of control rate signals is usually in the range 20-10,000 samples per second. Significantly, the periodic frequency of audio tones is in about the same range as the sampling rate of control rate signals. This is significant because control rate signals are typically used to control the pitch, volume or timbre of audio tones. Pitch is related to the periodic freqency of zero crossing points of an audio waveform. Volume is related to the peak amplitude of an audio waveform. Timbre is related to inflection points or waveshape of an audio waveform, and may also involve other aspects of a tone, including noise content, changes over time, and salient characteristics. So each data point of a control rate signal corresponds roughly to a single waveform of an audio tone.

Electrical signals generated in response to selection gestures made by the user are also used to control electronic musical instruments. These signals are discrete event data representing “notes”. The term note is used here to refer to any continuous audio signal. To distinguish from notes having primarily noise or varying pitch content, an audio signal having perceivable discrete pitch content is referred to herein as a tone. This distinction is made because the wide availability of MIDI based audio equipment has made it commonplace for piano style keyboards and other interfaces designed to facilitate playing of musical tones, to be used to play sounds of any description, usingothe keys of the piano style keyboard. So selection of sounds using the keys of such a keyboard, or other device are referred to as note selections. Note selections may also be used to determine the value of one parameter for an audio signal. For example, MIDI note numbers selected with a piano style keyboard typically represent a selected pitch for a pre-selected audio signal.

In the present invention, note selections refer to discrete selections of continuous data. Note selection data events are typically generated by contacting a fixed location on a continuous line or plane. Examples are striking the keys on a piano style keyboard, or selecting a position along a fretboard or continuous membrane. Such a selection may be seen as the endpoint of a continuous user gesture that is typically activated perpendicular to a line or plane. Note selections occur at what is defined here as “interaction rate” and generate “interaction rate event data”. Interaction rate events occur at roughly the same rate as zero crossing, or peak amplitudes, or inflection points of control rate signals. Thus discrete interaction rate event data may also be generated when operating a continous control operator, by crossing position, velocity, or acceleration thresholds, by starting stopping or changing direction of motion, or by intersection with a time threshold. Gestures performed by a user to interact with an electronic audio system may thus be represented by interaction rate event data.

Musical gestures may be separated into “selection gestures” and “activation gestures”. For example a note is selected on a violin using one hand, and then the note is activated using the other. The action of bowing may be represented by interaction rate events for start, change of direction and stop points, and by control rate signals connecting these points, representing velocity or position of the bow. Once the note is activated, additional notes may be both selected and activated by performing selection gestures with the fingerboard.

There are also “modulation gestures” which are used to vary a sounding note. Modulation gestures include vibrato, portamento slides, and other pitch variations, as well as subtle variations in volume and/or timbre of a sounding note. Modulation gestures may also be represented by interaction rate events connected by control rate signals.

So selection gestures may refer to note selection. Activation gestures may refer to note activation. Modulation gestures may refer to modification of activated notes. However, each of these three types may also be subdivided into selection, activation and modulation gestures. That is, just as notes are selected, activated and modulated, gestures are also selected, activated, and modified, each of which gesture may be represented by an interaction rate event.

For example, notes may be activated on a guitar by picking with an up or down stroke, or by bowing or striking a string. So an activation gesture itself is selected using a gesture that positions the hand to perform the selected gesture. Then the activation gesture is itself activated, which activates the note.

There may also be more than one type of note selection gesture. Notes may be selected on a guitar by fingering a string, or by releasing a string leaving the string open, or by fingering and then bending a string prior to activation. Note selection also consists of three parameters, representing three ranges of resolution, which may be selected separately. These are base note selection (open string), note increment selection (fret), and fine note selection (bend) all of which may be done prior to activation. Each of these three ranges of pitch selections may be made separately or together, before or after activation of a note. Volume and timbre may be selected and varied in similar ranges.

Some of the many types of modulation gestures have been mentioned. However, sometimes a gesture is not so easily classified. For example, after a note is activated, a new note may be selected by hammering on a new fret or fingerboard position. This is a selection gesture that is also a modulation gesture of a sounding note. In a sense, it is also an activation gesture, since the action of hammering the string down on a fret produces perturbations of the sound that are distinguishable aurally as a characteristic of a new note activation. The new note selected by a hammer-on gesture may then be activated anew with a picking gesture, which is a commonly used technique.

So there is a blurring of the distinction between selection, modulation, selection, and activation gestures. Each gesture may serve more than one purpose, each of which is a contributing factor to the listener's perception of its meaning within a musical context. Gestures may thus blend one into another. This is not just sloppy musicianship. It is intentional and very effective for creating continuity within a musical “phrase”. A musical phrase may thus be represented by a series of interaction rate events representing user selection, activation and modulation gestures, each of which may overlap to create a sense of continuity.

The MIDI data protocol is a widely accepted standard specification for representing interaction rate events and control rate signals. It is designed to facilitate implementation of tone synthesizer with a piano style keyboard, and with optional control operators. When playing such a keyboard based MIDI synthesizer, notes are selected by a tranverse gesture along the keyboard and activated by a motion perpendicular to the selected key. However, MIDI sends a single packet of data representing simultaneous selection and activation. Selection and activation events are combined into a MIDI note-on. However, advantages can be obtained by separating note selection and activation.

Some MIDI wind controllers, such as a Yamaha WX7 internally specify separate selection and activation data, used to generate MIDI note-on and note-off data. Similarly, guitar controllers may also used separate selection and activation data and also channelization of the strings, so gestures may be performed separately for each note activated by each string. Janosy, ICMC 1994, specifies separating MIDI note selection and activation data for the purpose of simulating guitar playing on a piano style keyboard. Janosy also specifies a chord mode channel for playing chords selected by one finger, and also a kind of solo mode for playing lines, that includes recognition of modulation gestures. Further, Janosy identifies a number of typical gesture types used in guitar playing.

However, all of the above fail to specify means of selecting and activating gestures, or significantly, for blending gestures to create phrases. All the above implementations also fail to recognize that notes may be advantageously channelized according to activation gesture or modulation gesture, as well as selection gesture, or that these represent performance modes that may themselves be selected and activated by the user. Thus, advantages may be obtained by separating selection and activation of notes, gestures and performance modes, and by making these selections and activations available to the user via an Interactive Performance Interface, as will be seen presently.

Besides the problem of MIDI note-ons and note-offs, it is a well-known limitation of MIDI that continuous control rate signals generated by specified control operators, modulate all sounding notes at the same time. This is rarely the case in a real musical performance, and generally makes for uninteresting sounding music. A new standard called ZIPI was developed, but not commercialized, which is based on the model of an orchestra rather than a piano style keyboard. It specifies that continuous control rate signals may be directed to individual notes so that each note may be modulated separately. However for an individual musician to modulate each note separately and distinctly from other notes, he or she must perform separate modulation gestures for each note, a difficult if not impossible task for polyphonic music. Otherwise, an entire orchestra of musicians is required, each playing a separate electronic instrument playing and modulating one note of a polyphonic ZIPI synthesizer.

One enhancement to the MIDI specification that addresses this limitation is called “Polyphonic Aftertouch”. This provides a type of data that is applied to each note individually. It is designed so that pressure pads under each note of a piano style keyboard may be used to modulate that note discretely. However, this arrangement requires that each modulation gesture be started after a note is activated and resolved before the note is deactivated, which only occasionally occurs in traditional music performance. Besides that, modulation gestures cannot be applied selectively to groups of notes, or across a sequence of notes using Polyphonic Aftertouch.

Another enhancement to MIDI is called MONO mode. This allows for only one note at a time to sound. If a second note is played before releasing the previous note, the second note continues the first note with only a change in pitch. However, new notes played this way in MONO mode simply starts a new note, but without the attack portion of the pre-programmed control envelope. If a note is played after all previous notes have been released, the new note is re-attacked. Such an arrangement is ineffective for creating realistic or varied transitions between notes.

This problem is partially addressed in U.S. Pat. No. 5,216,189, to Kato (1993), which specifies selectable preset curves which can be used to create note transitions. Unfortunately this requires a fingering scheme commonly known as “fingered portamento” that requires that a note be held down while additional notes are selected in order to effect simulated note transitions. This requirement is awkward at best and does not allow for lateral displacement of the hand along the keyboard, a staple piano keyboard technique.

In U.S. Pat. No. 6,316,710, Lindemann, provides a variety of pre-composed audio files that may be activated to create realistic sounding note transitions. Lindemann also provides a “sound segment sequencer”, that processes user actions and makes decisions about what audio file to play. Significantly however, Lindemann only provides the example similar to the fingered portamento scheme described above, wherein a MIDI style note-on signal such as from a wind controller be maintained in order to create slur transitions. The above examples fail to recognize the importance of different performance modes for interacting with instruments, represented by selection and activation gestures, and by selection and activation gestures for the performance modes themselves, because they fail to recognise the role different modes of operation of arms, hands and fingers play in a musical performance.

The inventor has discovered that audio synthesis systems work by mirroring perceptual modes used to hear and process audio signals. This discovery was extended to physical devices such as loudspeakers that mirror human ears, and control devices that mirror human limbs. The inventor further extended this theory to include the simulation of muscle activation required when interacting with a musical instrument, which was the subject of U.S. Pat. No. 6,066,794 cited above. In the present invention, the inventor extends the analogy of reflection to include the operation of joints and limbs via discrete decisions a musician-user makes, to finally create an infinitely flexible performance interface that stands in stark contrast to the prior art.

Such an electronic interface can provide a means of changing the roles played by the physical devices used to interact with the sound production circuitry, via a hierarchy of conditional latches encoded in the interface electronics. This reflects the way a musician temporarily changes the position and/or orientation of arms, hands and fingers in order to interact with an instrument in different ways. It suffers from neither the physical difficulties imposed by the construction of traditional instruments, nor from the narrow performance options provided by prior art electronic interface circuitry. The present invention discloses such an Interactive Performance Interface.

### SUMMARY OF THE INVENTION

The inventor has discovered that a flexible, easy to use performance interface for an audio system, can be designed by representing electronically the decisions and actions a musician makes in performance. Traditional musical instruments necessarily reflect the modes of movement of the human body. But the interface of an acoustic instrument is limited because it must support an internally resonant acoustical system. This is why acoustical instruments usually take years to learn to play well.

For example, a guitar fretboard is arranged so a musician's fingers may be positioned transversely across the strings, in order to select chord voicings. The musician's hand can also be rotated, so the fingers fall longitudinally in succession along the frets of a single string. These are two performance modes for a guitar. However these gestures are notoriously difficult for a beginning guitarist to perform, because they also require interacting with strings implemented to cause the guitar body to resonate.

However, these performance modes can be represented electronically by modeling the action of the fingers and hand. The decision to use one or the other can also be modeled, and the option to switch from one to the other provided to the performer via an electronic performance interface. Because an electronic interface does not suffer from the limitations imposed by the necessity of manipulating a resonant acoustical system, both the selection of modes and performance actions may be made available to the user via simple operators that are comfortable to use.

Thus the present invention provides a performance interface architecture for an audio synthesizer, that can simulate musical decisions as well as the performance actions of musicians using interactive performance modes. Since the present invention is implemented in the electronic domain, it is ideally flexible for representing the kinds intricate and multidimensional musical relationships between notes and gestures found in traditional music.

In a conventional synthesizer, each interaction gesture, such as striking a piano style keyboard, typically activates an audio rate signal and at least one automatically performed control signal called an “envelope”. An envelope may be defined as consisting of a series of interaction rate event data points, with control rate signals that interpolate between data points, according to pre-selected parameters. Thus an envelope may be thought of as an “interaction rate signal”.

Interaction rate signals have a longer period than control rate signals, being in the general range of “human actions”. Human actions consist of a series of gestures combined to produce a given result. For example, the action of throwing a baseball consists of a combined series of sequential and simultaneous gestures of almost every joint in the human body, mainly the shoulder, arm, elbow, wrist and hand. Each of the separate gestures have a start point and an endpoint, each of which may be represented by an interaction rate event. These may also be seen as data points of an interaction rate signal representing the human action of throwing a baseball.

As will be shown, it is advantageous to make the series of interaction rate signal data points of a synthesizer control envelope available for manipulation by the user. This can be done by implementing an “interactive control envelope” for which each data point is synthesized in response to user selection and activation gestures. Thus in contrast to the prior art, the present invention synthesizes interaction rate signals via interactive control envelopes. These may be used in place of the traditional pre-programmed control envelopes in a tone synthesizer, or may be used to supplement or supercede them at will.

In the present invention, a synthesized interaction rate signal represents a phrase. A phrase may be one note with a number of variations to pitch or other parameters. It may also be a hierarchical design of notes, including a volume or pitch pattern, or a pattern of harmonization or orchestration. A phrase is generally initiated by a distinguishing characteristic segment referred to as an “Attack”. For a phrase that consists of a single unbroken tone, the Attack segment may be generated by what is referred to in the art as a “biasing gesture”. A biasing gesture is a gesture required to keep an instrument at an operating point, and may include bowing or blowing. A phrase once initiated, generally includes additional “Continuation” segments, which may have their own hierarchy. Each such component segment has an initiation point which occurs at interaction rate. So a phrase may be represented by an interaction rate signal that includes an Attack segment, and is composed of a hierarchical combination of interaction rate data points. Each segment of the phrase may be represented as an interpolation at control rate and/or audio rate between data points.

In the present invention, interaction rate signals are synthesized by interactive control envelopes in response to user gestures that generate interaction rate event data. Interaction rate signals are also acted on and modified by other interaction rate signals. Control rate signals are generated in response to user gestures and are acted on and modified by interaction rate signals and also control rate signals. Audio rate signals may be interpolated from control rate signals, synthesized by conventional wave table or physical modeling methods, played back from stored samples, segments or partials, or otherwise be generated responsive to the interaction rate and control rate signals. Audio rate signals may themselves be modified by audio rate signals.

It is an objective and advantage of the present invention to make available to the user a number of “performance modes” implemented by a hierarchy of interactive control envelopes, that are activated by user manipulation of input devices. Once a performance mode or interactive control envelope is activated, it is also latched, so the user's hands are free to perform additional interaction gestures. Each performance mode may be represented as at least one interactive control envelope, plus the audio signals and control rate gestures specified to be activated by interaction rate signal data from the envelope.

The device that latches on a control envelope is referred to as an “Attack Latch”. It is activated by interaction rate event data generated by a user gesture, and synthesizes an initial data point of an interaction rate signal or “Attack Data”. This Attack Data may be used to activate an audio signal and may also activate a control rate signal that functions as an Attack segment of a phrase. Attack Data may also enable and sometimes select a second Attack Latch that represents a second level in an interactive control envelope hierarchy.

Attack Data may also function within an interactive control envelope to select a “Continuation Latch”. One or more Continuation Latches may be used to synthesize additional data points of an interaction rate signal, referred to as “Continuation Data”, when activated by interaction rate events generated by user gestures. Continuation Data may activate audio signals and control rate signals representing additional segments of a phrase.

For example, a note selection may be used to simulate a guitar hammer-on, so that the pitch of a sounding string changes by the difference between the pitch represented by the note selection and the previous pitch. Then a note deselection may be used to simulate a pull-off to an open string, so the pitch drops to a base pitch, or to a pitch one or two octaves below the selected pitch. Note selections may also be used to simulate gestures such as damping a string by touching it to stop it from sounding before subsequent note activations.

Thus interaction rate event data generated by note selections and deselections, and also by operator deflection and release, are used to select and activate data points of a synthesized interaction rate signal representing a phrase.

In one embodiment of the invention, referred to as “Line Mode”, selected notes are channelized discretely. They may then be activated by a single activation gesture, according to an interactive control envelope referred to a “Line Envelope”. Alternatively they may be activated sequentially by a series of activation gestures. Thereafter modulation gestures may act on sounding notes simultaneously or sequentially. Notes thus channelized may be harmonized, and control rate and audio signals follow a harmonization scheme. In a variation of this embodiment, all selected notes may be grouped on one channel until activated by a separate gesture. Notes are thus channelized according to an activation gesture, as performed using an interactive control envelope. Additional selected notes may be grouped on another channel, allowing further activations without deactivating previously activated notes. Fewer channels are required for the latter scheme, but harmonization of gestures is limited. In a variation of this embodiment, notes may be channelized by the operator used to activate notes, or by direction of operator deflection.

In another embodiment of the invention, referred to as “Channel Mode”, notes are channelized discretely by selection gestures which also activate notes. Since notes are activated separately and discretely, modulation gestures may effect notes activated at different times differently, according to an interactive control envelope referred to as “Channel Envelope”. Note modulations may also follow a harmonization scheme. In an alternative embodiment, notes may be selected and activated on one channel until activation of a modulation gesture, whereupon they are grouped on a separate channel. Notes are thus channelized according to a modulation gesture performed using a Channel Envelope. Similarly to Line Mode, fewer channels are required for the latter scheme, but harmonization of notes is limited. In a variation of this embodiment, notes may be channelized by the operator used to activate a modulation, or direction of operator deflection.

In the above modes, notes are dynamically allocated to open selection channels or activation channels, and control rate signals are only sent to channels for which notes are activated. These performance modes can be implemented using the current MIDI specification, by dynamically assigning notes to separate output channels and routing control rate signals only to appropriately selected channels.

Other objects and advantages of the invention will be made apparent by the following drawings and description.

### BRIEF DESCRIPTION OF THE DRAWINGS

FIG. 1 shows an Interactive Performance Interface with user input devices and audio generator.

FIG. 2 shows interaction rate event data generators and Phrase Synthesis.

FIG. 3 shows an overview of Phrase Synthesis architecture.

FIG. 4 shows a circuit diagram for a Channel Envelope.

FIG. 5A shows a circuit diagram for a Transparent Latch.

FIG. 5B shows a circuit diagram for an Edge Triggered Latch.

FIG. 6 shows Visual Basic code modules that simulate the circuit elements depicted in the Figures.

FIG. 7A shows a code module for a basic Channel Envelope Forward Attack Latch.

FIG. 7B shows a code module for a basic Channel Envelope Forward and Reverse Attack Latch.

FIG. 8A shows a code module for a Channel Envelope Forward Attack Latch

FIG. 8B shows a code module for a Channel Envelope Forward and Reverse Attack Latch.

FIG. 9 shows a circuit diagram for a Line Envelope.

FIG. 10 shows a code module for a simple Line Envelope Forward and Reverse Attack Latch

FIG. 11A shows a code module for a Line Envelope Forward Attack Latch.

FIG. 11B shows a code module for a Line Envelope Forward and Reverse Attack Latch.

FIG. 12 shows a Visual Basic code module for a Line Envelope Attack Latch.

FIG. 13 shows an alternative Visual Basic code module for a Line Envelope Attack Latch.

FIG. 14 shows a Visual Basic code module for a Line Envelope Forward and Reverse Attack Latch.

FIG. 15 shows an alternative Visual Basic code module for a Line Envelope Forward and Reverse Attack Latch.

FIG. 16 shows an alternative circuit for a Line Envelope Forward Attack Latch and Reverse Attack Latch.

FIG. 17 shows a Line Sub-Envelope.

FIG. 18 shows the note selection storage and activation for the Channel Envelope.

FIG. 19 shows the control signal select and generation for the Channel Envelope.

FIG. 20 shows the note selection storage and activation for the Line Envelope.

FIG. 21 shows the control signal select and generation for the Line Envelope.

FIG. 22 shows a circuit for a Fingered Attack Latch.

### DETAILED DESCRIPTION

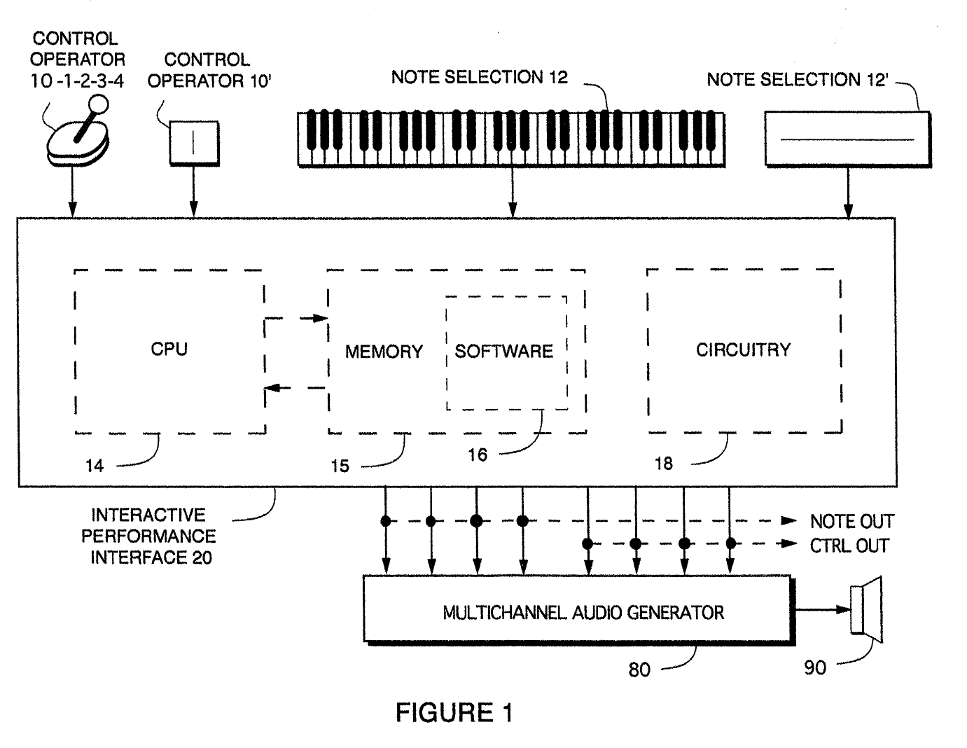

FIG. 1 shows an overview of an Interactive Performance Interface with accompanying user input devices and tone generator. Note Selection 12 depicts a piano style keyboard of the sort typically used to simultaneously select and activate notes of a MIDI synthesizer. In the present invention, a musician may use the keyboard only to select a note, or a parameter of a note such as frequency or pitch, to be generated by activation of a control operator. Alternatively, any electrical or mechanical device which can detect a position selected with a selection gesture may be used, represented in FIG. 1 by Note Selection 12′. Selections are usually made by intersecting the selection device with a motion perpendicular to a line or plane. Examples of alternative devices include a continuous pad or membrane, a simulated guitar neck or violin neck, or even a light beam capable of detecting position when a hand passes through it. If the selection device is continuous, as per a control ribbon, the position data may be quantised to a specified resolution. Another device that senses motion or position and generates continuous control data may be used to generate a discrete selection signal by stopping motion or by sampling at a given point in time.

Once a note is selected, a continuous device such as Control Operator 10-1-2-3-4 shown in FIG. 1 may be used to activate and/or modify it. Pictured is a four way joystick controller. Alternatively, any device or devices that can output a continuous control rate signal representing a continuous user gesture, or continuous modulation of applied force by the user, may be used. Such an alternative control operator is represented in FIG. 1 by Control Operator 10′. Operation of a control operator is specified in terms of motion or pressure along a one dimensional axis. Such motion or pressure has two directions, referred to in the present invention as “deflection” and “release”. The pictured joystick is specified as four operators, each of which may be deflected and released by the user. Alternatively, the terms forward and reverse, up and down, left and right, or other terms that describe a user gesture that progresses to an apex and returns to a starting point may be used. A continuous circular gesture may be represented as viewed from the edge, or be described by a sine wave that has positive and negative portions and zero crossing points.

Interactive Performance Interface 20 may be embodied as a processor or CPU 14, coupled to a Memory 15 that preferably includes random access memory and read only memory, where Software 16 is stored or loadable into Memory 15. As such Memory 15 is a computer readable medium (without limitation magnetic, storage, optical storage, etc.) that can hold Software 16. Upon execution by processor or CPU 14, Software 16 may carry out at least one of the functions of generating interaction rate event data in response to user operation of a specified input device or devices, synthesizing an interaction rate signal in response to the interaction rate event data, and synthesizing control rate data responsive to the synthesized interaction rate signal. Alternatively or in addition, any of these functions may be embodied in circuitry 18. Circuitry 18 includes standard electronic components so configured as to carry out one or more of the above functions.

Multichannel Audio Generator 80 outputs audio signals according to the data input from Interactive Performance Interface 20. Multichannel Audio Generator 80 may be a MIDI synthesizer or synthesizers, a multi-channel sound card for a personal computer, audio generation circuitry or dedicated DSP processor, including memory storage for use with a CPU such as CPU 14, or other audio signal generation device specified to activate audio signals responsive to data received from Interactive Performance Interface 20. Audio signals are output to Loudspeaker 90 provided for use with Multichannel Audio Generator 80.

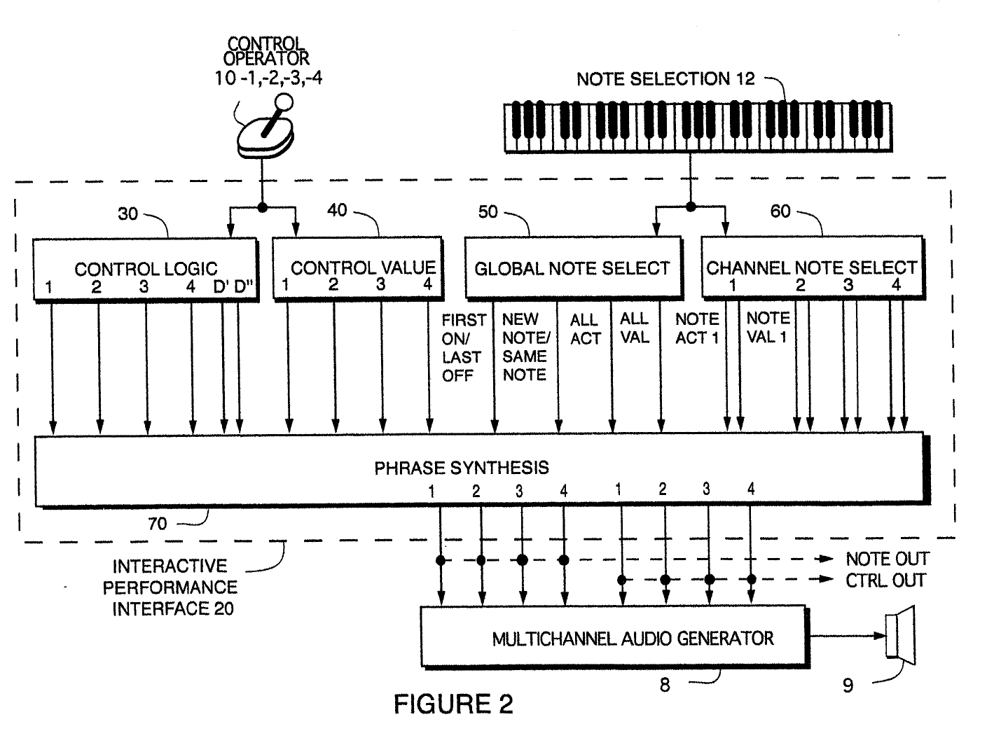

FIG. 2 shows functions for generating interaction rate event data and continuous control rate data used to synthesize interaction rate signals and control rate signals in Phrase Synthesis 70. Channel Note Select 60 outputs interaction rate selection data for each note selected with Note Selection 12 on a discrete channel. Alternatively notes may be grouped on a single channel until activated, whereafter notes are grouped another channel. Or notes may be grouped on one channel and activated on that channel until activation of a modulation gesture, whereafter notes are grouped on another channel. Accordingly, a feedback path may be provided from an interactive control envelope to signify when notes are to be grouped on another channel. Alternatively, notes may be channelized according to selection as depicted, but then grouped according to activation or modulation when output to Multi-Channel Tone Generator 80, using channel data derived from an interactive control envelope in Phrase Synthesis 70. Notes are thus channelized according to selection, activation, or modulation.

A number representing selected position, or note number for each selection made with Note Selection 12 is output from Channel Note Select 60 to Phrase Synthesis 70. Interaction rate event data representing selection and deselection for each channel is also output from Channel Note Select 60 to Phrase Synthesis 70.

If notes are channelized discretely, data representing repeated selections and deselections of the same notes are output on the same channel, while data representing new note selections are output on new channels. When selections have been made for all channels, channels are reused and old stored selections are lost. Channels may be reused in a cyclically rotating fashion or according to some other selection hierarchy.

Global Note Select 50 processes note selections and outputs interaction event data global to all selections regardless of channel. “First On/Last Of f” data sends a logical true for a transition from no notes selected to one or more notes selected, and sends a logical false for a transition from one or more notes selected to no notes selected. “New Note/Same Note” data sends a logical true for a transition from a selected note to a new note and a logical false for a repeat selection of the same note. All Activate, abbreviated All Act, sends a logical true for each note selected and a logical false for each note deselected. All Value, abbreviated All Val sends a position value for each note selected. Data [symbol] output from Global Note Select 50 is input to Phrase Synthesis 70.

It will be appreciated that the functions of Channel Note Select 60 and Global Note Select 50 may be integrated into the performance modes themselves. It is convenient for the purposes of illustration and discussion to separate them so their purpose may be more easily understood.

Continuous control rate signals may represent position, and/or velocity, and/or acceleration. Velocity and acceleration data may be derived from position data. Additional processing may be necessary to derive position data along a specified axis or dimension in space. In FIG. 2, Control Value 40 processes position data detected from Control Operator 10-1-2-3-4 and outputs four control rate signals to Phrase Synthesis 70, one for each direction of motion of the depicted joystick.

Continuous control rate data may also be derived from an audio signal for use by the Phrase Synthesis functions. The audio 10 signal may be output from Phrase Synthesis 70, or other source. Control rate data thus derived may be generated by detecting zero crossings, amplitude of periodic audio wave forms, local and maxima and minima and/or inflection points.

Interaction rate event data representing activation, deactivation or change of direction of a control operator, or motion along an axis is also useful in Phrase Synthesis 70. Such a signal may be used to simulate activation of a string, such as bowing or plucking. The activation signal may be a logical 1, representing a logical True for activation and 0 representing logical False for deactivation. Alternatively, a logic signal of 1 may indicate motion in one direction and a 0 indicate motion in the opposite direction. Detected pressure or change of direction of motion may generate such data. The endpoint of an operator deflection, an ending threshold of a deflection, an interaction rate time threshold, or detection of zero motion may also generate usefull interaction rate event data. It isn't necessary to use the numbers 1 and 0. Any symbols or numbers, such as a plus and minus or positive and negative numbers may be used to indicate forward and reverse direction, or activation and deactivation. In this case, 0 may be used to represent no motion. Control Logic 30 in FIG. 2 derives interaction rate event data from continuous control rate data input from Control Operator 10-1-2-3-4 and outputs the interaction rate event data to Phrase Synthesis 70. It will be appreciated that the functions of Control Logic 30 and Control Value 40 may be integrated into the performance modes themselves.

Phrase Synthesis 70 outputs interaction rate signals synthesized in Phrase Synthesis 70 continuous control rate signals, activated by interaction rate signals synthesized in Phrase Synthesis 70. The interaction rate signals and control rate signals may each be used to activate and modulate audio signals generated by Multichannel Audio Generator 80

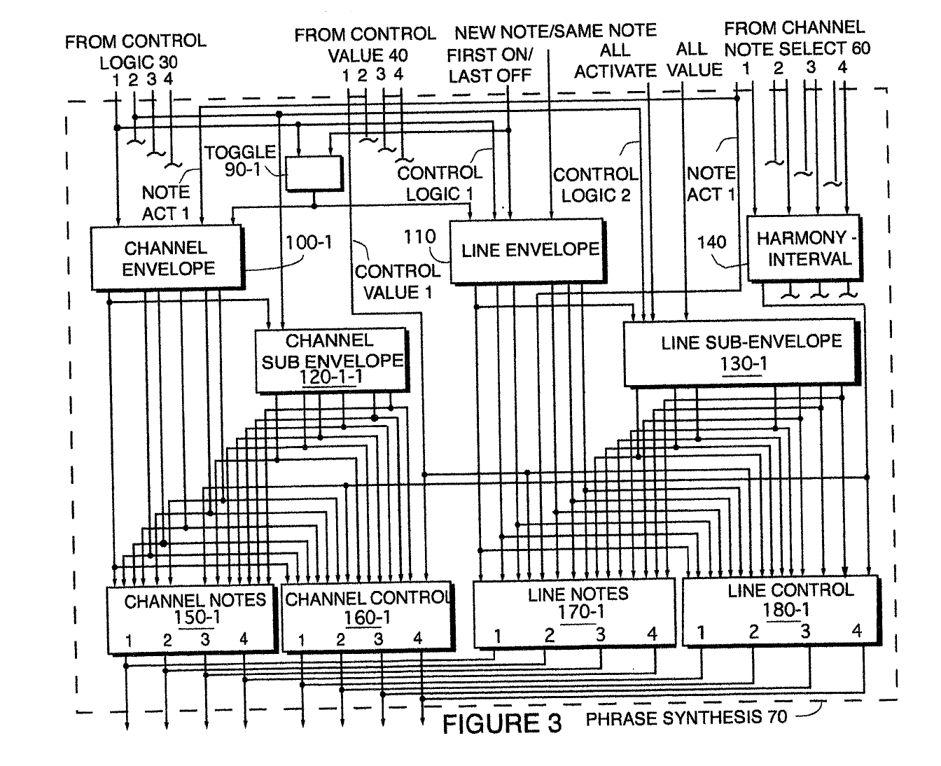

FIG. 3 depicts function blocks representing elements of Phrase Synthesis 70. These elements are arranged according to a logical hierarchy of latches. Each latch results from a selection and activation gesture made by the user. The function of a latch is to remember that a sequence of selection and activation gestures were performed. Once set to a logical True, a latch remains True even though the user deselects or releases at least one of the selection device or control operator used to perform the selection and activation gestures. In other words, the logical input conditions that activated the latch may change, but the output remains the same, until a specific set of input conditions are met that deactivate the latch. Once a latch is thus activated, the selection device and/or control operator may be reused for further selection and/or activation gestures.

Attack Latch True and False events correspond to the events that start the Attack and Release segments of a traditional synthesis control envelope. They may each also be used to activate different audio signals, so that different sounds may be used for the Attack and Release portions of a phrase.

The Attack Latch that activates an interactive control envelope typically selects at least one Continuation Latch that can then be activated to send additional events used for Phrase Synthesis 70. These correspond to starting points for continuation segments of a traditional control envelope, such as Decay and Sustain. They may also be used to activate different audio signals. The Attack Latch may enable a second Attack Latch that is used to activate a Sub-Envelope. Several Sub-Envelopes may be accessible by working through a hierarchy of latches.

Two performance modes are depicted in FIG. 3, Line Mode and Channel Mode, alternately enabled by Toggle 90-1. As depicted in Phrase Synthesis 70, Channel Mode includes Channel Envelope 100-1 and Channel Sub-Envelope 100-1-1. Line mode includes Line Envelope 110 and Channel Envelope 110-1. In the present embodiment, once a user deselects all notes, Toggle 90-1 can be activated by deflecting and releasing Control Operator 10-1 activates Toggle 90-1. It will be appreciated that another series of selection and activation gestures may be used to activate Toggle 90-1, or that it's functions may be integrated into the performance modes themselves. Not shown are Toggle 90-2-3-4 which may be provided for activation by Control Operator 10-2, 10-3 and 10-4. These may alternately switch between additional performance modes provided for the user.

In a simpler embodiment, a single performance mode may be implemented. Or instead of Toggle 90-1-2-3-4 a hierarchical menu or series of buttons may be provided for the musician to select between a multiplicity of performance modes. However it may be more advantageous to the user to switch between performance modes using the selection device and control operators in a similar manner to navigating among interactive control envelopes.

When Channel Envelope 100-1 is enabled by Toggle 90-1, the Forward Attack Latch is also selected and may be activated by interaction rate event data Note Act 1, from Channel Note Select 60. Otherwise, Channel Envelope 100-1 is first selected by interaction rate event data Control Logic 1 from Control Logic 30 and then activated by Note Act 1. These selection and activation gestures cause Forward Attack Data or Reverse Attack Data to be synthesized by Channel Envelope 100-1 and sent to Channel Notes 150-1 and Channel Control 160-1. Not shown are Channel Envelopes 100-2-3-4, which are selected and activated by interaction rate event data from Note Act 2, 3 and 4 of Channel Note Select 60. Interaction rate signal data synthesized by Channel Envelopes 100-2-3-4 are sent to Channel Notes 150-2-3-4 and Channel Control 160-2-3-4 also not shown. Note selections values from Channel Note Select 60 may also be sent to Channel Notes 150-1-2-3-4.

In the depicted embodiment, audio signals and control rate signals are activated on separate channels by Channel Envelopes 100-1-2-34. In an alternative embodiment, audio signals may be activated on one channel by Channel Envelope 100-1 Forward Attack Data and on another channel by Channel Envelope 100-1 Reverse Attack Data.

Once activated, Forward or Reverse Attack Latches remain latched until other selection and activation gestures cause them to be deactivated. Forward and Reverse Attack Data sent to Channel Notes 150-1 may also each activate different audio signals associated with each of Forward and Reverse Attack True and Forward and Reverse Attack False. Each of these Attack Data sent to Channel Control 160-1 may also activate a control rate constant signal, in place of, or in addition to a continuous control rate signal.

Continuation Latches are enabled and selected within Channel Envelope 100-1 by Forward or Reverse Attack Data. Depicted are Forward and Reverse Continuation Select and Continuation Operator. Continuation Data is synthesized in response to selection and deselection of notes using Note Selection 12 or deflection and release of Control Operator 10-1. Additional Forward and Reverse Continuation Data may be synthesized in response to deflection of Operator 10-2-3-4, but this is not depicted.

Each Continuation Data thus synthesized is sent to Channel Notes 150-1 and Channel Operator 160-1, and each may activate different audio signals as well as continuous control rate signals or control rate signal constants. Likewise, Continuation Data synthesized by Channel Envelopes 100-2-3-4 may be sent to Channel Notes 150-2-3-4 and Channel Control 150-2-3-4.

Channel Sub Envelope 120-1-1 is enabled and selected by Attack Data from Channel Envelope 100-1. Channel Sub Envelope 120-1-1 is thus a second level in the latch hierarchy. The interaction rate signal data synthesized by Channel Sub Envelope 120-1-1 may be used in Phrase Synthesis 70 in place of, or in addition to Channel Envelope 100-1 Continuation Data.

The advantage of this arrangement becomes evident when more than one control operator used. For example, not depicted are Channel Sub-Envelopes 120-1-2, 120-1-3 and 120-1-4. Once Channel Envelope 100-1 is activated and latched, operation of each additional Control Operators 10-2-3-4 may activate separate Sub-Envelopes. Once a Sub-Envelope is itself activated and latched, separate Continuation Data may be synthesized using each of the other three operators.

So there are a multiplicity of separate Continuation Data that may be synthesized starting with Channel Envelope 100-1 and progressing to any of four Sub-Envelopes via different pathways. Each Sub-Envelope synthesizes is own Attack Data and Continuation Data. All the interaction rate signal data may be sent to Channel Notes 150-1 and Channel Control 160-1 to be used to activate separate audio or control rate signals. Additional sets of Sub-Envelopes may be implemented to be enabled by each of Channel Envelope 100-2-3-4, and the interaction rate signal data synthesized by these sets of Sub-Envelopes sent to Channel Notes 150-2-3-4 and Channel Control 160-2-3-4.

It will be appreciated that the functions of all these interactive control envelopes may be integrated into one large interactive control envelope. They are separated here for the purposes of illustration and discussion so that their operation may be more clearly understood. It will also be appreciated that fewer than four channels or more than four channels may be implemented in Phrase Synthesis 70.

Line Envelope 110 and Line Sub-Envelope 130-1 work in a similar manner to that described above for Channel Envelope 100-1 and Channel Sub-Envelope 120-1-1. Attack and Continuation Data synthesized by Line Envelope 110 and Line Sub-Envelope 130-1 are sent to Line Notes 170-1 and Line Control 180-1 for use in Phrase Synthesis 70. One difference is that in the present embodiment, Line Envelope 110 may be used to activate all four channels of audio and control signals simultaneously. Alternatively, Line Envelope 110 may synthesize channelization data according to activation, to be used by Line Notes 170-1 and Line Control 180-1. The workings of both Channel Envelopes and Line Envelopes will be discussed in more detail presently.

Often two or more notes are selected and activated simultaneously, as will typically be the case in the present embodiment of the Line Envelope 110. Modifications to the activated notes performed by Phrase Synthesis 70 may include pitch bend. In the prior art, pitch bend performed by a control operator bends all notes the same amount. However the resulting chord may not fit into the harmonization scheme of the music, resulting in a discordant sound. This limitation exists because all notes are activated and controlled on one channel.

In the present invention, two or more channels are provided for activation of notes. So pitch bend modulation may be made on several channels simultaneously by deflecting a single control operator, according to a harmonization scheme determined by Harmony-Interval 140. When a pitch bend gesture is activated, Harmony-Interval 140 sets the interval of the pitch bend for each channel by fitting the sounding notes into a flat or a hierarchical harmonization scheme, and determining an appropriate bend interval for each note. Harmony-Interval 140-1 data is sent to Channel Control 160-1. Harmony-Interval 140-2-3-4 data are sent to Channel Control 160-2-3-4, not shown.

The prior art provides for automatic pitch glide from one note to the next in Mono mode or fingered portamento mode. Both of these are limited to one sounding note. In the present invention, two or more channels are provided so that multiple activated notes may glide from one note to the next according to selections made with Note Selection 12. In the depicted implementation, simultaneous selections are necessary to activate simultaneous pitch glides. Alternatively, automatic pitch glides may be made on one channel at a time, in a cyclic manner. The interval between successive notes is computed by Harmony-Interval 140 and interval data sent to Line Notes 170-1 and/or Line Control 180-1 for use in Phrase Synthesis 70. It will be appreciated that a variety of simulated gestures for moving continuously from one pitch to the next may be provided. For example, these may include a control rate signal for a simulated guitar hammer-on, or an audio rate signal for a valve closing on a wind instrument.

In another embodiment, note deactivations may activate a control rate or audio rate signal such as a simulated pull-off. If many notes are selected simultaneously, a pull-off gesture may be generated as each note is deselected. Each deselection may pull-off to a pitch determined by one of a number of possible embodiments. For instance, a deselected note may pull-off to the pitch of the next most recently selected note, or the nearest in pitch, or the furthest in pitch, or the next most recently selected furthest in pitch, or the inventor's favorite—the nearest in pitch that is the highest or lowest note still held. Or another method may be used to determine the pitch of the pull-off note. When the last note is deselected, the pitch may fall to a constant base note, or a note one or two octaves below the last deselected note. Or deselection of all notes may cause a gesture that reverts to the initially activated note, thus simulating a note that has been plucked or bowed, then a series of hammer-ons added and then pulled-off.

An appropriate interval for each hammer-on or pull-off is determined according to a scheme implemented in Harmony-Interval 140. The selection and deselection interval data is sent to Line Notes 170-1-2-3-4 and Line Notes 180-1-2-3-4 for use in Phrase Synthesis 70.

### Description of the Channel Envelope

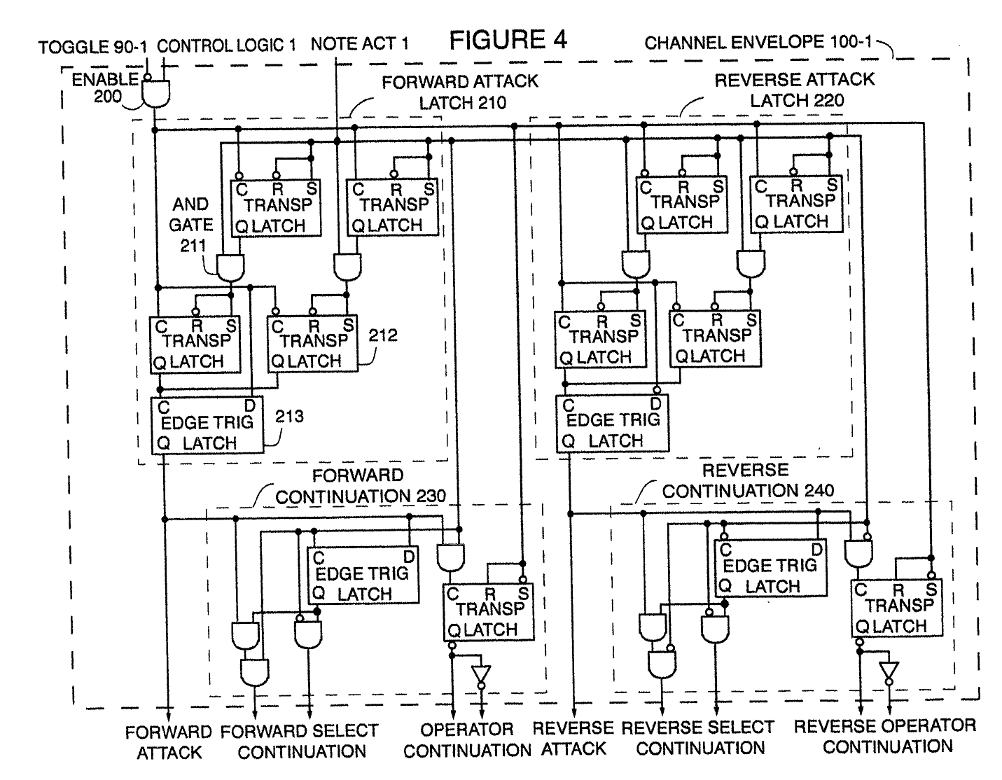

FIG. 4 is a generalized circuit diagram for a Channel Envelope 100-1. This circuit can be realized using standard electronic components. It can also be simulated using computer code. Code for each type of circuit element pictured is given in FIG. 3A. The functions of Channel Envelope 100-1 can also be accomplished using simpler blocks of code to be discussed presently. However it may be easier to see how Channel Envelope 100-1 functions by examining the circuit diagram.

Enable 200 is an “And Gate”. One input to the And Gate is from Toggle 90-1. When Toggle 90-1 is False, logic data from Control Logic 1, is passed through the gate to Forward Attack Latch 210, Reverse Attack Latch 220, Forward Continuation 230 and Forward Continuation 240. All functions of the Channel Envelope 100-1 are thus enabled. Interaction rate event data labeled Control Logic 1 is generated by Control Logic 30 in response to user operation of Control Operator 10-1. Interaction rate event data labeled Note Act 1 is generated by Channel Note Select 60 in response to user operation of Note Select 20. So when Channel Envelope 100-1 is enabled by Toggle 90-1, the user may interact with Channel Envelope 100-1 using Control Operator 10-1 and Note Select 20.

When Channel Envelope 100-1 is first enabled, Forward Attack Latch 210 is selected. Otherwise Forward Attack Latch 210 is selected when a logical False is received from Note Act 1, followed by a logical False from Control Logic 1. After Forward Attack Latch 210 is thus selected, Forward Attack Latch 210 is activated and latched when a logical True is received from Note Act 1.

In terms of user actions, this means that if the note or notes represented by Note Act 1 are deselected and Control Operator 10-1 is deflected and then Control Operator 10-1 is released, Forward Attack Latch 210 is selected. Then the next note that is selected for Note Act 1 activates and latches Forward Attack Latch 210. Forward Attack Data is synthesized by Forward Attack Latch 210 and sent to Channel Control 150-1 and Channel Notes 160-1 and may be used to activate audio and/or control rate signals. From here on, unless otherwise state, reference to operation of Note Selection 12 and Control Operator 10-1-2-3-4 are understood to mean that interaction rate event data is generated in response to user operation, by Channel Note Select 60 and Control Logic 30 respectively, and input to Channel Envelope 100-1.

Forward Continuation 230 is selected by Forward Attack Latch 210. Forward Continuation Data is synthesized by deflecting and releasing Control Operator 10-1 and by deselecting and then reselecting notes with Note Selection 12. Interaction rate signal data thus synthesized is sent to Channel Note 150-1 and Channel Control 160-1 and may be used to activate different audio or control data signals.

Similarly, if the note is deselected and then Control Operator 10-1 is deflected, Reverse Attack Latch 220 is selected. If the same note is selected again, Reverse Attack Latch 220 is activated and latched. Or Reverse Attack Latch 220 may be activated and latched by a different note if all other channels are subsequently used, so that Note Act 1 of Channel Note Select 60 must be reused.

Reverse Continuation 240 is selected by Reverse Attack Latch 220. Reverse Continuation Data is synthesized by deflecting and releasing Control Operator 10-1 and by deselecting and then reselecting notes. Interaction rate signal data thus synthesized is sent to Channel Note 150-1 and Channel Control 160-1 and may be used to activate different audio and control rate signals.

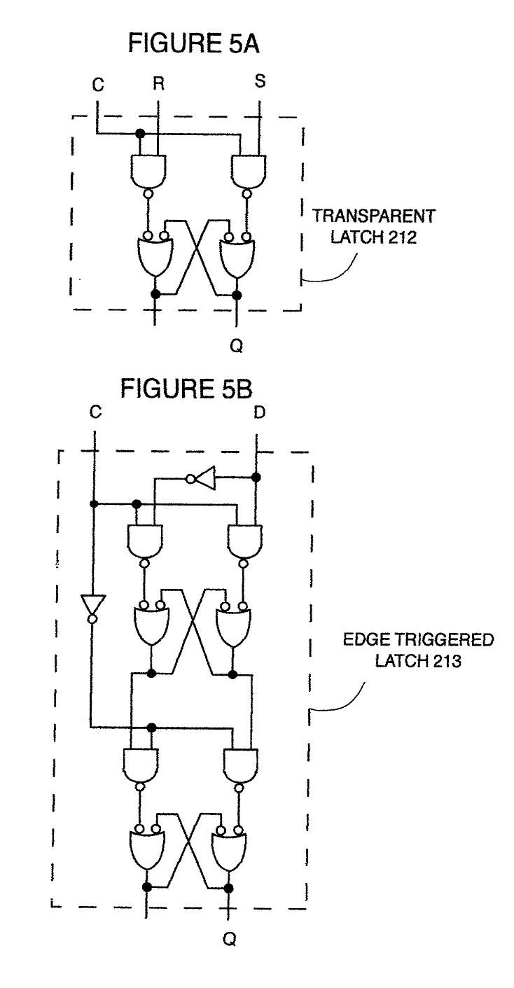

Transparent Latch 212 in FIG. 3 is a standard circuit element based on a flip flop. It has a Set, Reset and Clock input. As used in these circuits, the Set and Reset inputs are tied together with the Reset inverted from the Set. FIG. 5A shows a simple circuit diagram for Transparent Latch 212.

Edge Triggered Latch 213 in FIG. 3 is a negative edge triggered type D flip-flop. It uses two flip flops in a master slave configuration. A simple circuit diagram for a Edge Triggered Latch 213 is shown in FIG. 5B. Alternatively a positive edge triggered 7474 TTL flip flop or JK flip flop may be used. It will be appreciated that other arrangements of the depicted circuit elements will yield the same results.

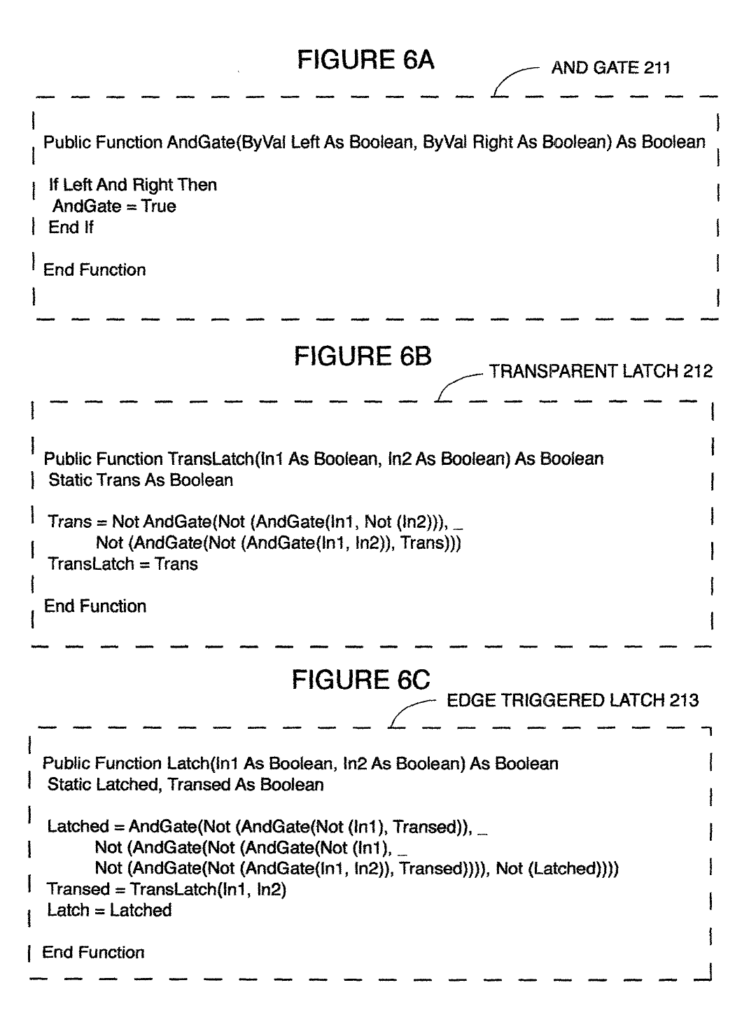

And Gate 211 in FIG. 3 can be represented by simple Boolean operations as embodied in the Visual Basic code module shown in FIG. 6A. FIG. 6B shows a code module that can be used to simulate a Transparent Latch 212. It calls the module in FIG. 6A. FIG. 6C shows a code module, which can be used to simulate the action of Edge Triggered Latch 213. It calls both the modules in FIGS. 6A and 6B. These modules may be used in a similar way to build simulations of the disclosed circuits in the present invention. For example a module that simulates Forward Attack Latch 210 would have three input variables, and be called every time an input changes. Changes in the output causes other modules to be called, simulating circuit elements connected to Forward Attack Latch 210. Or a single module with a number of output variables, that makes calls to modules simulating the disclosed circuit elements, could simulate the operation of Channel Envelope 100-1. Other code for implementing elements of Channel Envelope 100-1 will be disclosed presently.

The following will illustrate a possible use for the Channel Envelope 100-1 as embodied in Phrase Synthesis 70. In the prior art, if a pitch bend is performed and then a second note is played after the first one is bent, the second sounds higher by the bend amount. So the second note sounds at a higher pitch than it's selected position on the keyboard. This problem is partly solved by activating each note on a separate channel and only sending bend data to channels with activated notes. So a bend sent to one channel doesn't affect other notes. Or all notes can be activated on one channel until a bend is activated. Then notes are sent on another channel.

It might be supposed that such an arrangement would require a simple switch such as an And Gate, that turns on the pitch bend for channels with activated notes. However if the note that is bent is deselected and the bend released, the bend will be turned off, and the previously bent amount retained when the bend operator is released, instead of bending back down. Then when another note is activated, it will be at the bent pitch. So it's necessary to send a constant pitch bend number when the note is activated, which is probably a 0, in order to make sure it is activated at it's correct pitch.

The above scheme still has a flaw however. If a note is deselected and then reselected before the bend is released, a constant pitch bend number is sent, and the note sounds again at it's original selected pitch rather than the pitch was bent to. So it is desirable that the pitch bend not only be switched on and initialised when a note is activated, but that it be latched on. The objective is that a note that is activated and then bent and then deselected should remain bent, while other notes that may be activated in between are not bent.

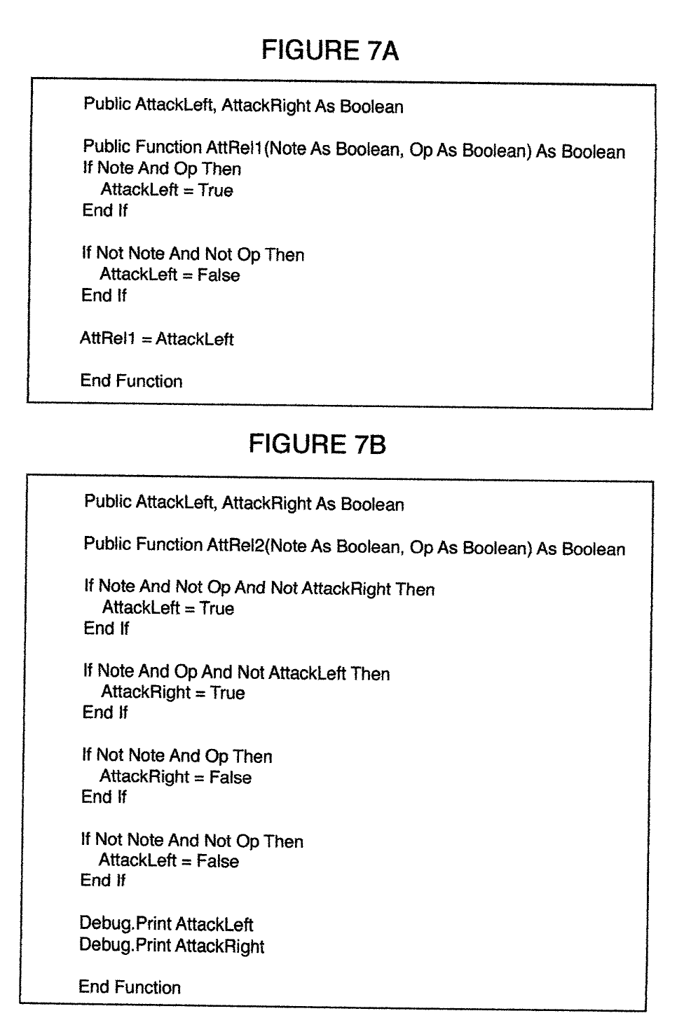

Code for a simple Attack Latch that may be used for to implement this is shown in FIG. 7A. When the output of the module is True, pitch bend is activated. Notes are activated independently of the module output. There are two sequences of user gestures that will activate this Attack Latch, operator release followed by note selection, or note selection followed by operator release. In each sequence, the first is the selection gesture and the second is the activation gesture. Likewise there are two sequences that deactivate the Attack Latch. In other embodiments to be described presently, there is only one gesture sequence that will activate an Attack Latch and one that will deactivate it.

This code, and other code implementations to be discussed presently, may be included as part of a computer program designed top implement a basic Channel Envelope as disclosed in the present invention. Actions, such as calls to other modules, occur for changes of state of the data output from the module, similarly to the leading and trailing edge of a clock pulse that causes a change of state of a latch circuit. Likewise the module is called by changes of state of the input variables. In this example, the variable “Note” represents Note Act 1 data. The variable “Op” represents Control Logic 1 data. To implement latches for other embodiments these may be interchanged, or variables representing interaction rate event data generated by Control Logic 30, Global Note Select 50, or Channel Note Select 60, may be substituted.

It may also be desirable to bend a note down that is activated after a first note is bent up. Since the control operator performing the bend is already deflected, it is necessary to start the bend for the second note at a zero amount and bend to a negative amount. This may be done if the second note is bent on a second channel, and a separate pitch bend control signal starting from 0 is used. But if the second note is deselected and later reactivated, it is necessary to reinitialise the pitch bend again at 0 for it to be activated at it's selected pitch. This embodiment requires both a Forward and Reverse Attack Latch.

Code that can be used to implement a simple Forward and Reverse Attack Latch is shown in FIG. 7B. The command “Debug.Print” is used to output the Forward and Reverse Attack Data for demonstration purposes, as represented by the variables “AttackLeft” and “AttackRight” respectively. It will be appreciated that identical results may be obtained in these embodiments by using nested conditional statements that only test one variable at a time, instead of the disclosed Boolean logic operations of two or three variables.

In the code shown in FIG. 7B, the previously determined value of output variables are used in the logic operations. It will be appreciated that in place of these variables, interaction rate event data derived from the output of control rate signals, that are activated by Attack Data synthesized by the module may be used. This implementation can allow for activated control rate signals to be completed, or another condition met, before the output of the module changes again. Similarly, interaction rate event data derived from an audio signal that is activated by Attack Data synthesized by the module, or by a control rate signal activated by Attack Data synthesized by the module, may be used in place of the output variable of the module itself, for conditional operations within the module. These modifications may also be made to other code implementations of Attack Latches disclosed in the present invention.

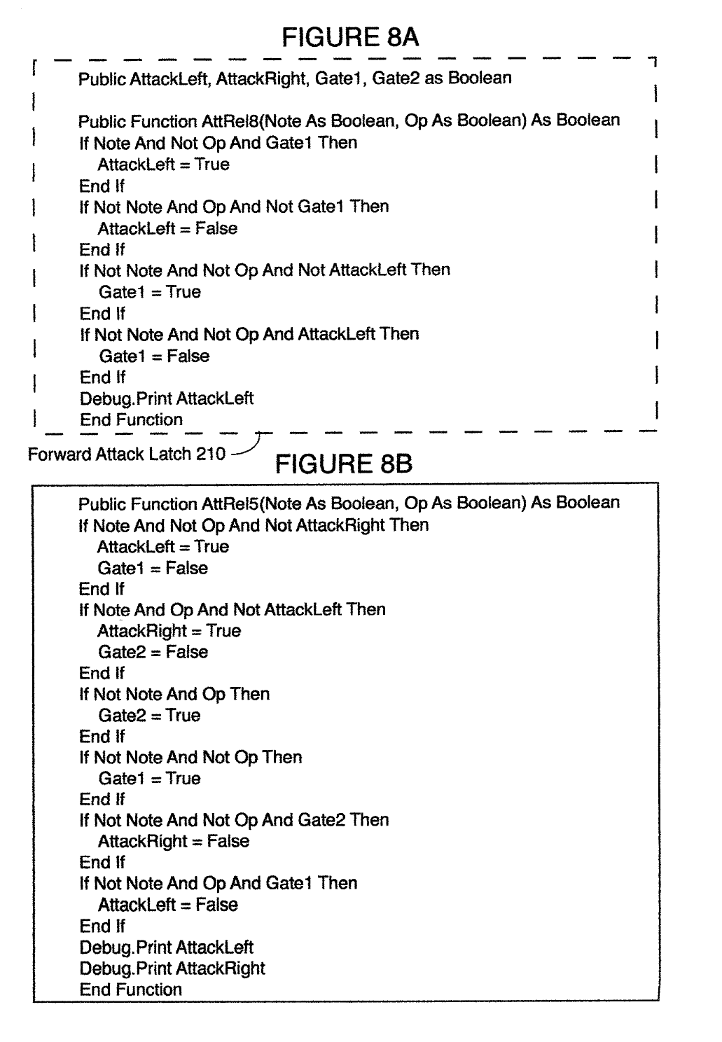

The more complex Attack Latches depicted in Channel Envelope 100-1 have the advantage that once activated and latched, they stay latched, until a specific deactivation sequence is performed. So the interaction rate signal they synthesize can be used to activate both audio and control signals. FIG. 8A shows a code module that may be used to implement Forward Attack Latch 210. This code requires the use of an intermediary variable, “Gate1” that stores the result of conditional operations in between calls of the module. FIG. 8B shows a code module that can be used to implement Forward Attack Latch 210 and Reverse Attack Latch 220 combined. This function requires the use of two intermediary variables, “Gate1” and “Gate2”.

### Description of the Line Envelope

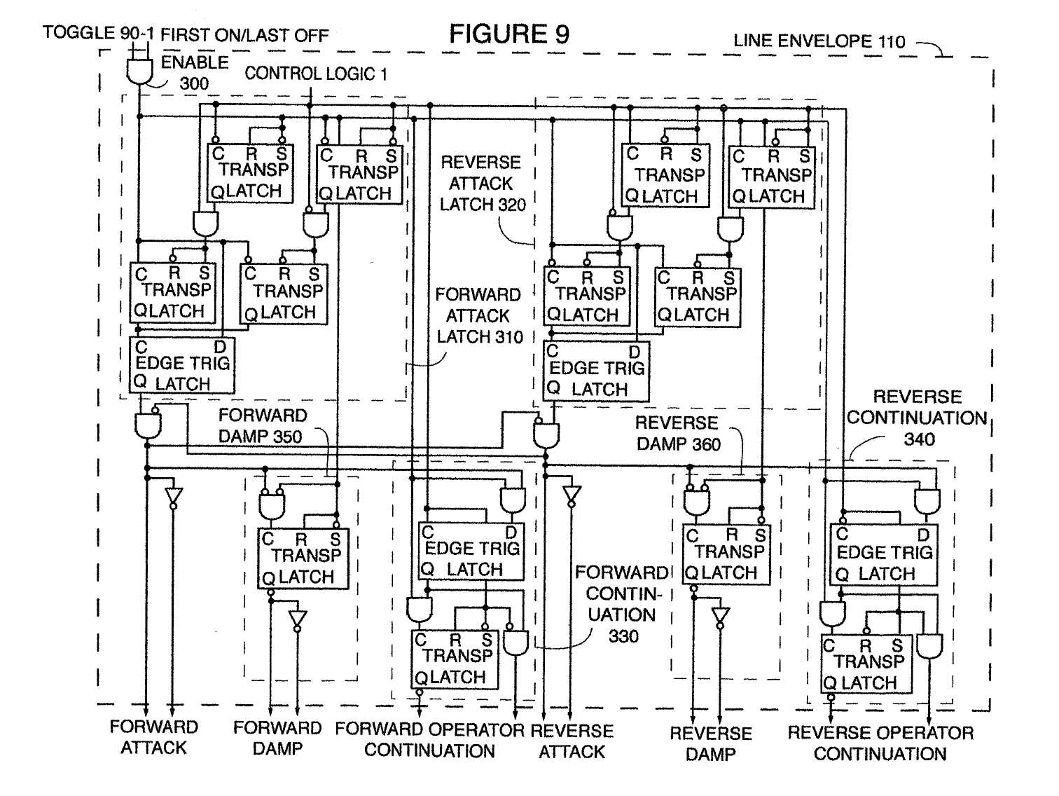

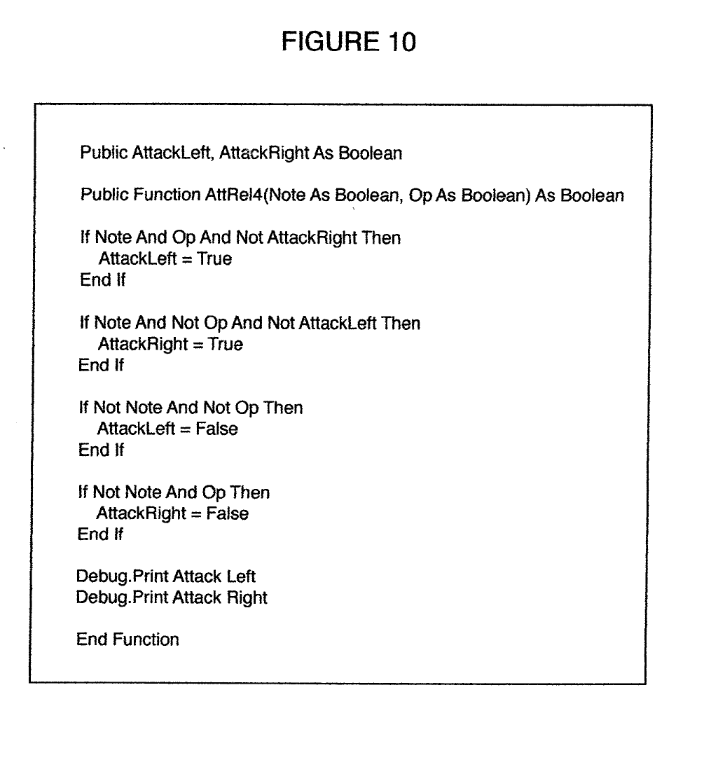

FIG. 9 is a generalized circuit diagram for a Line Envelope 110. It looks and operates in a similar manner to the Channel Envelope 100-1. The roles of Note Selection 12 and Control Operator 10-1 are reversed for Line Envelope 110 That is, selection of an Attack Latch is accomplished using Note Selection 12 while activation is accomplished using Control Operator 10-1. Line Envelope 110 may be used to simulate the actions of first selecting a note on a fretboard and then activating it with a separate gesture, such as plucking a guitar, or bowing a violin. For such an implementation, a velocity value may be input from Note Selection 12, or derived from deflection of Control Operator 10-1 using two threshold detectors, or from successive control rate data values. Velocity data may be used in similar ways to MIDI note-on velocity.

In Line Envelope 110, Enable 300 is an And Gate. Once Enable 300 receives a logical True from Toggle 90-1, Line Envelope 110 is enabled. Incoming First On/Last Off data from Global Note Select 50 is passed to the components of the envelope. Selecting a note with Note Selection 12 then selects Forward Attack Latch 310. Then deflecting Control Operator 10-1 activates and latches Forward Attack Latch 310. This synthesizes Attack Data and a logical True is sent to Line Notes 170-1 and Line Control 180-1 for use in Phrase Synthesis 70.

Thus a note may be selected and then activated by a separate control operator. The note may be activated directly by Attack Data synthesized by Forward Attack Latch 310, or the Attack Data may activate a control rate signal from which interaction rate data is derived and used activate an audio signal. Interaction rate data may be derived from an activated control rate signal by a threshold detector, for example. Or the control rate signal itself may activate an audio signal, as is sometimes the case with physical modeling audio synthesis. The control rate signal may itself be controlled by continuous control rate data from a control operator. Such an arrangement allows for a kind of “flex” activation that closely simulates the motion of picking or bowing a note for example. In such an embodiment, the control rate signal that activates an audio signal may start before the audio signal it generates, which may initiate a phrase. Such a time lag is natural when playing acoustic instruments, and typically a musician accounts for it. However, it may be seem more natural for a musician accustomed to playing a MIDI synthesizer, for interaction rate signal data to start a physical model from some initial bias state.

Another control rate signal or the same one, may be used as modulation data for the audio signal. For example, a simulated guitar slide of an octave or more, synchronized with note activation, is a stylistically recognizable gesture often used to initiate a phrase.

Once Forward Attack Latch 310 is activated, Forward Continuation 330 is selected. Additional notes may then be activated by moving Control Operator 10-1 in a back and forth motion while holding the note. Similarly to the action of Forward Attack Latch 310, the notes may be activated directly by synthesized Continuation Data, or Continuation Data may activate a control rate signal that may be continuously controlled by Control Operator 10-1 and that is then used to activate an audio signal. Since Forward Attack Latch 310 is already activated, an introductory control rate gesture and/or introductory audio signal isn't repeated.

Continuation Data synthesized in response to repeated deflection and release of Control Operator 10-1 can also be used to cumulatively vary one or more parameters of an activated audio signal. Or a preset sequence of audio or control rate signals may be activated by Continuation Data synthesized in response to repeated deflections of Control Operator 10-1 or another Control Operator.

Once all notes are deselected and then Control Operator 10-1 is released, Forward Attack Latch 310 is deactivated. This generates a logical False Attack Data, which can be used to activate a final audio or control rate signal, such as a simulated guitar slide down.

Reverse Attack Latch 320 is activated in a similar fashion to Attack Latch 310. First releasing all notes, then deflecting Control Operator 10-1 then selecting a note, selects Reverse Attack Latch 320. Releasing Control Operator 10-1 then activates and latches Reverse Attack Latch 320. Attack Data thus synthesized by Reverse Attack Latch 320 may activate a different initialisation control rate and/or audio rate signal from the Attack Data synthesized by Forward Attack Latch 310. Reverse Latch 320 activation may also select a different set of Continuation Latches and possibly a different Sub-Envelope from Attack Latch 310.

Reverse Continuation 340 works in a similar manner to Forward Continuation 330. Once Reverse Attack Latch 320 is activated, Reverse Continuation 340 is selected. Note selections and deselections may be made without deactivating Reverse Attack Latch 320. Holding a note while deflecting or releasing Control Operator 10-1 synthesizes Reverse Continuation Data, which may be used to activate additional audio and control rate signals. Reverse Continuation Data may also deactivate previously activated signals. Or all audio signals may be deactivated by False Attack Data synthesized by Reverse Operator Latch 320 deactivation. Alternatively, activated signals may continue for a preset time, or until deactivation Continuation Data is received. Or activated signals may continue for a time determined by some other function of Phrase Synthesis 70.

Another feature of Line Envelope 110 is Forward Damp 350 and Forward Damp 360. Forward Damp 350 is selected when Forward Attack Latch 310 is deactivated, and activated by selecting a new note. A first “Damping Data” is thus synthesized and a second Damping Data synthesized when the selected note is deselected. Damping Data may be used the same way the second release segment of a traditional control envelope is used. For example, an audio signal may be allowed to continue sounding even after Forward Attack Latch 310 has been deactivated. Damping Data synthesized in response to a note selection then stops the previous signal from sounding. Or first Damping Data may activate a second final control or audio signal and then second Damping Data deactivate it. It will be appreciated that deflection of a Control Operator after Forward Attack Latch 310 is deactivated may also be used to synthesize Damping Data. A “Damp Latch” used to synthesize Damping Data may also be implemented as part of Channel Envelope 100-1 or a Sub-Envelope.

It will be appreciated that the Forward and Reverse side of Channel Envelope 100-1 and Line Envelope 110 can be interchanged. Other Attack Latches to be discussed presently, can also be substituted for one side or the other. Or an envelope may include only one Forward or Reverse Attack Latch.

An alternative Attack Latch may be activated by one operator and de-activated by a different operator. In a simpler embodiment, either direction of operation of a control operator may activate or deactivate a single Attack Latch. This requires a simpler circuit congiration, possibly including only one Edge Triggered Latch. However it doesn't allow for as much variation as having separate activation and deactivation gestures.

The code shown in FIG. 7A can also be used for a simple Line Envelope. In this case, synthesized Attack Data output from the module is used to activate audio signals. Control rate signals are generated independently. Audio signals can be activated by deflection of a Control Operator, once a note has been selected, or by note selection, once a Control Operator has been deflected.

FIG. 8 shows a simple embodiment of Forward and Reverse Attack Latches that can be used to implement a Line Envelope. In this embodiment, synthesized Forward and Reverse Attack Latch Data activate control rate signals, which then activate audio signals.

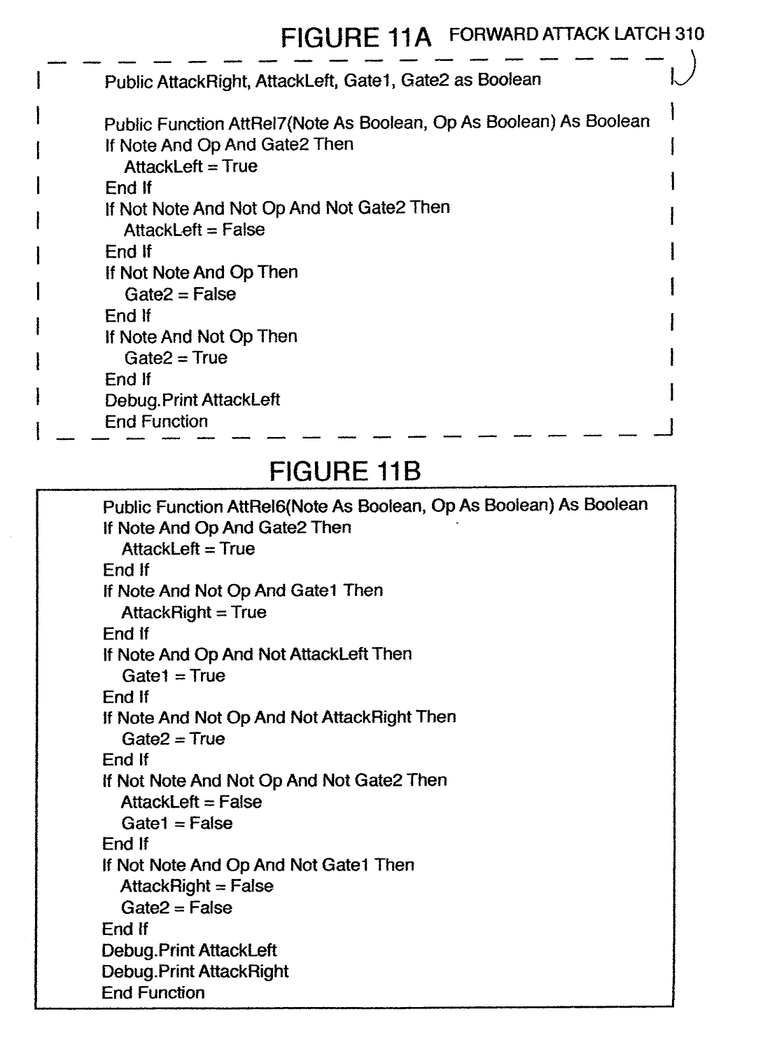

The embodiments made possible by the code modules shown in FIG. 7A and FIG. 9 suffer from the same limitations as the embodiments for a Channel Envelope previously discussed for FIGS. 7A and 7B. These limitations are resolved by the code shown in FIG. 11A which is similar to the code shown in FIG. 8A. This code also requires the use of an intermediary variable, “Gate1”. FIG. 11B shows code that can be used to implement a combination of Forward Attack Latch 310 and Reverse Attack Latch 320.

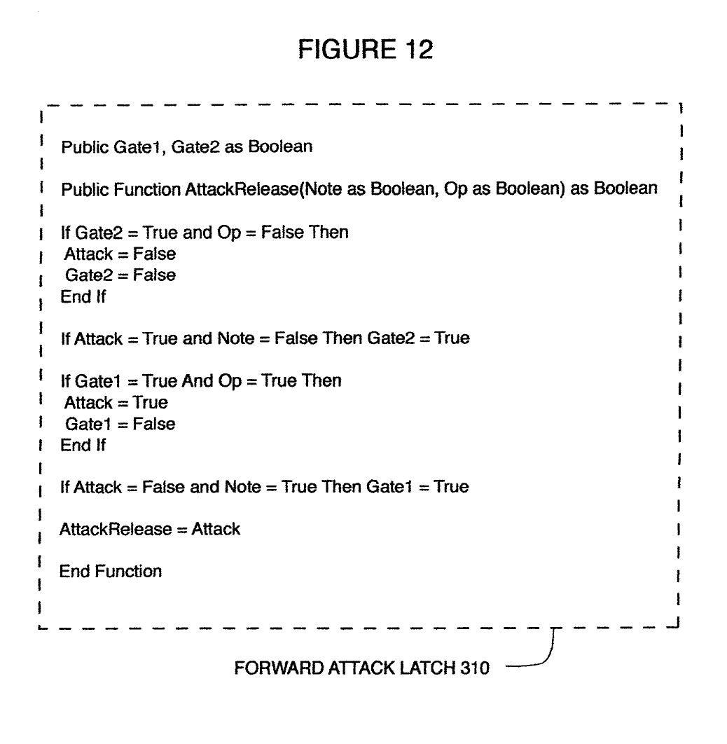

FIG. 12 shows a code module for Forward Attack Latch 310. There are two intermediary variables, “Gate1” and “Gate2” that provide an activation buffer between inputs and outputs. The content of these intermediary variables is stored in between calls to the module. So even though the module is called at least every time there is a change of input, the output doesn't necessarily change. Changes to the output require specific sequential changes of the input. A variation of the code shown in FIG. 12 can also be used to implement an Attack Latch for Channel Envelope 100-1.

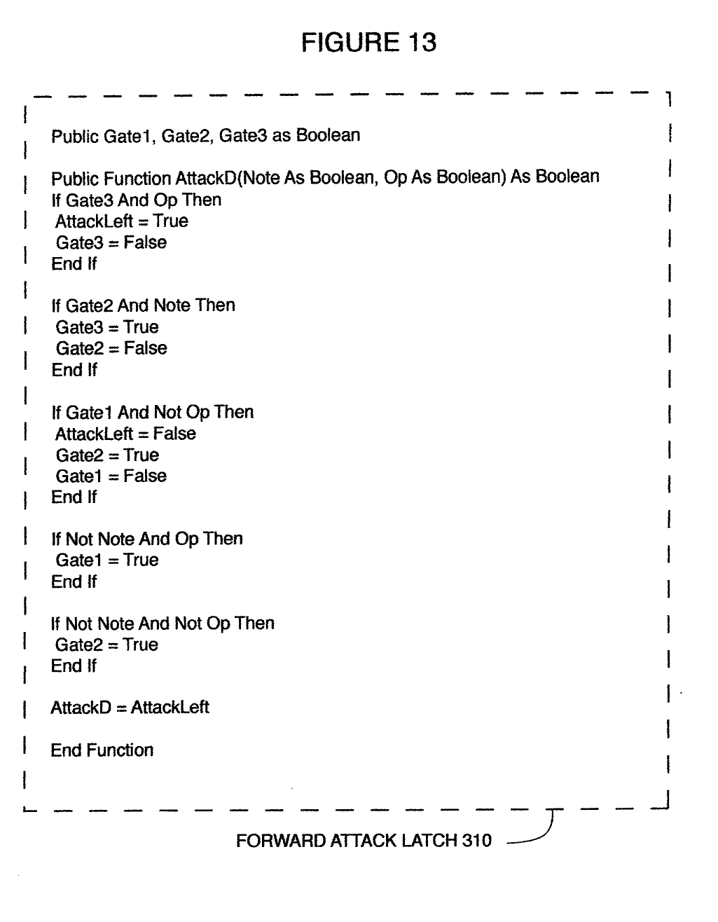

The code disclosed in FIG. 12 requires that the previous output of the latch be available within the module, for further calculations. It is also possible to implement a “top down” approach, which doesn't require that the previous output of the module be available for correct operation. Such a module is shown in FIG. 13. In this case, there are three variables, “Gate1”, “Gate2”, “Gate3” that retain their data in between calls.

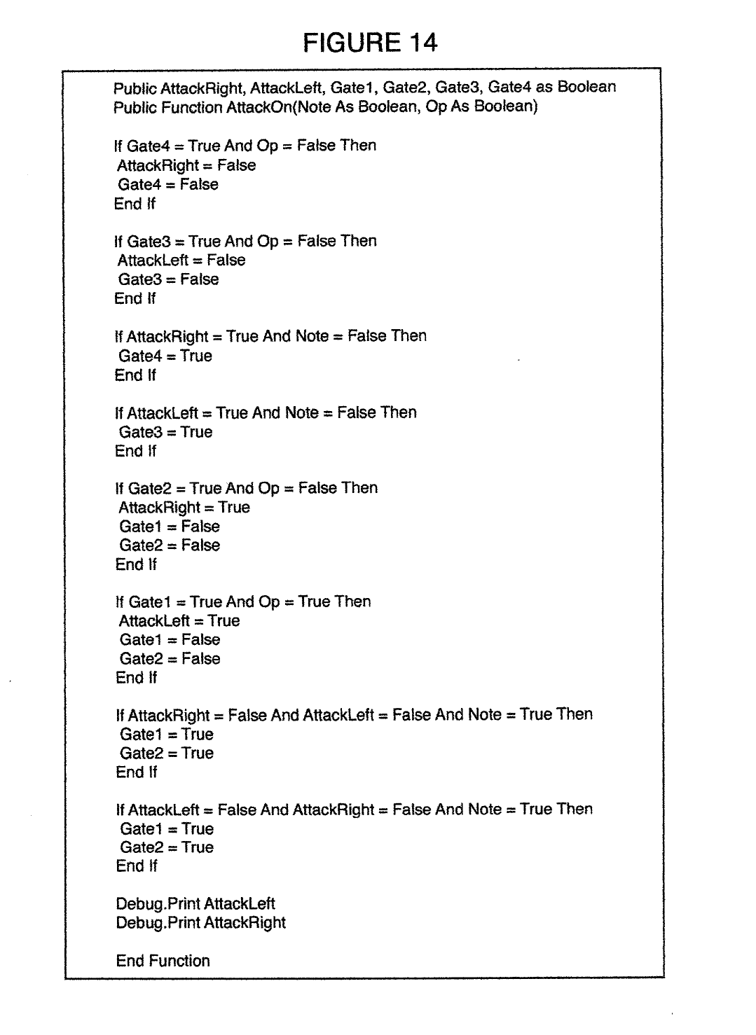

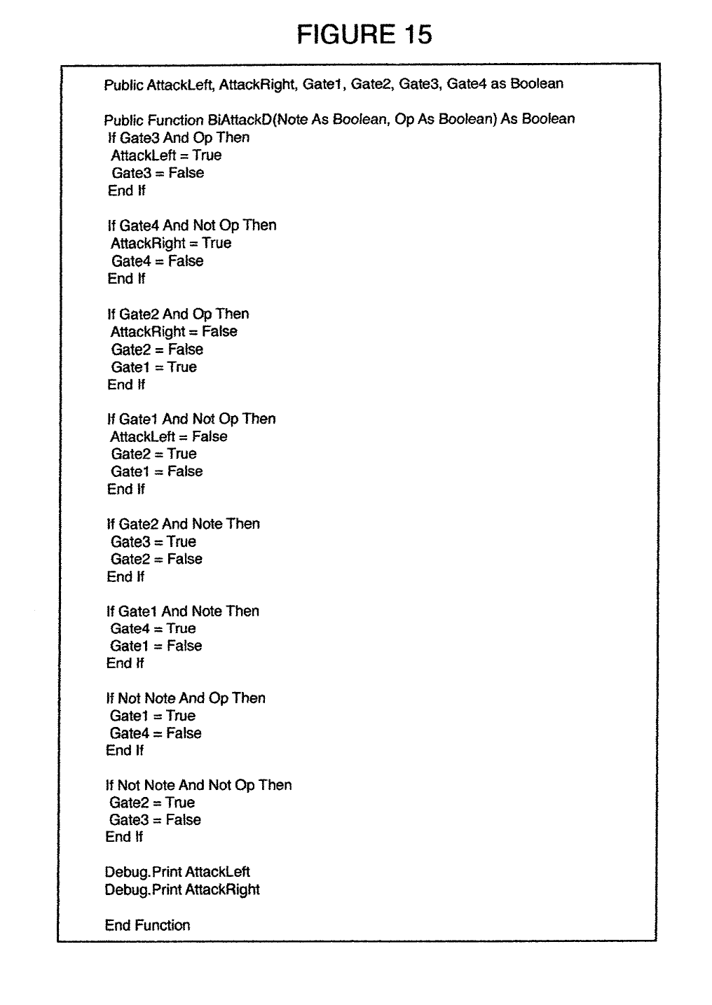

FIG. 14 shows a code module for Forward Attack Latch 310 and Reverse Attack Latch 320 combined. Four intermediary variables are required, “Gate1”, “Gate2”, “Gate3”, and “Gate4”. Since there are two outputs, these are defined as variables also, AttackLeft and AttackRight, instead of the output being returned by the function name as in previous modules. FIG. 15 also shows a code module for Forward Attack Latch 310 and Reverse Attack Latch 320 combined. This is a top down implementation like FIG. 13. It requires four intermediary variables, but doesn't require that the previous state of either AttackLeft or AttackRight be available for logic operations within the module.

It will be appreciated that code modules may be implemented that differ from those disclosed, or are written in a different language, but accomplish the same ends. In order to be usefull for the present invention, code that implements Attack Latches must have the minimum distinguishing characteristic that for the output to change, both input conditions change. Preferably, the output changes in response to a specific sequence of input changes. The latter requires the use of at least one intermediary variable that stores data resulting from previous calls. It is also a distinguishing characteristic of Transparent Latch 212, Edge Triggered Latch 213 and and other flip flop circuit elements that they “remember” the result of sequential input changes.

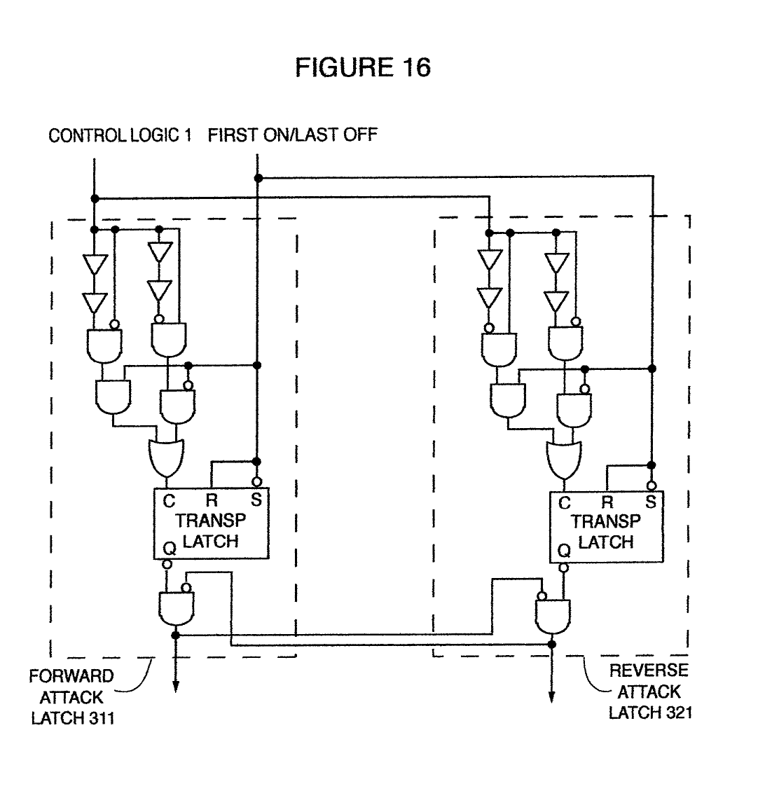

FIG. 16 shows an alternative circuit for the Forward and Reverse Attack Latches, which can be used to implement Line Envelope 210-1. Attack Latch 311 and Reverse Latch 321 each use a single transparent latch. Buffers that delay and invert incoming data signals are used to create one cycle clock pulses. Additional buffering elements to those shown may be necessary for correct operation of the circuit, depending on the components used. A simulated clock pulse may also be generated from controller deflection or note selection, using two threshold detectors. The first threshold detector sends a logical True and the second sends a logical False.

### Description of the Line Sub-Envelope

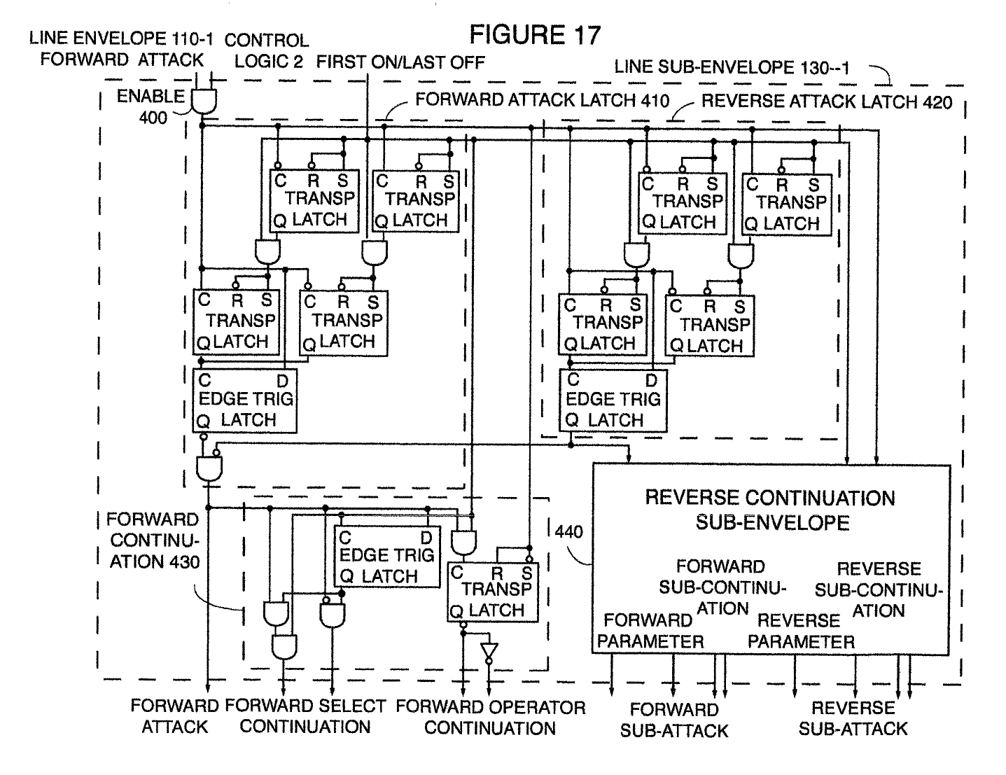

FIG. 17 shows a generalized circuit diagram for Line Sub-Envelope 130-1. Forward Attack Latch 410 in this circuit, closely resembles Forward Attack Latch 210 in Channel Envelope 100-1, because it's operation is very similar. As depicted, it's enabled by Forward Attack Data from Line Envelope 110. It will be appreciated that Forward or Reverse Attack Data from Line Envelope 110 may also be used to enable Line Sub-Envelope 130-1. Or two separate Sub-Envelopes may be provided to be enabled by Forward Reverse Attack data.

When Line Sub-Envelope 130-1 is enabled, Forward Attack Latch 410 is selected. Forward Attack Latch 410 is activated by a note selection, and synthesized Attack Data is sent to Line Notes 170-1 and Line Control 180-1 for use in Phrase Synthesis 70. This Forward Attack Data also selects Forward Select Continuation 430. Continuation Data may then be synthesized by selection of additional notes with Note Selection 12. As depicted, First On/Last Off data is used to activate Forward Selection Continuation 430. However, All Act data from Global Note Select 50 may be used, so that several notes can be selected and held, then released in succession, each deselection activating synthesized deselection Continuation Data. This embodiment may also require a variation of the depicted Forward Select Continuation 430. Continuation Data may also be synthesized by deflection of Control Operator 10-2. It will be appreciated that additional circuit elements to those shown may be provided so that additional Continuation Data may be activated by deflection of Control Operator 10-3 and 10-4. Deflection and release of Control Operator 10-3 and 10-4 may also select alternative Attack Latches, similar to the operation of Control Operator 10-2. Note selections may then activate these additional Attack Latches or may activate alternative Sub-Envelopes and select additional Continuation Latches.

Reverse Attack Latch 420 is selected when all notes are deselected and then Operator 10-2 is deflected. When a new note is then selected, Reverse Attack Latch 420 is activated. Forward Attack Latch 410 is simultaneously deactivated.

One application of the hierarchical arrangement of Line Envelope 110 and Line Sub-Envelope 130-1 is the simulation of slurred musical phrases. If a note has been previously activated by operation of Line Envelope 110, and a phrase thereby initiated, further note selections may activate audio signals and/or control rate signals via Line Sub-Envelope 130-1. These signals may be used to simulate slurred note transitions. In another embodiment, activation of Line Sub-Envelope 130-1 may scale the interval resolution of note selection values generated by Channel Note Select 60 or Global Note Select 50. Or interval resolution can be scaled dynamically. So successive note selections may activate simulated note transitions in fractional pitch amounts. Or successive note selections may be used to activate volume and/or timbre changes of activated audio signals in incremental amounts, the increment of which may also be varied in performance.

The interval or position values of the note selections may also be used to vary control rate parameters of activated gestures, as may MIDI type velocity data from note selections. Position and/or velocity and/or acceleration of operator deflection and release may also be used to vary parameters of audio signals and/or control rate signals.

In the present embodiment, an additional Sub-Envelope, Reverse Continuation Sub-Envelope 440 is pictured as part of Line Sub-Envelope 130-1. This is enabled by Attack Data from Reverse Attack Latch 420. Once enabled, note selections may be used to select interval distances for signals, which are subsequently activated by deflecting and releasing Control Operator 10-2. That is, a note is selected and held, while Control Operator 10-2 is used to activate an audio or control rate signal that traverses the interval. This process of selecting an interval parameter prior to activation of a control rate signal, by deflection of a control operator, is very similar to the sequence of selecting a note and then activating it by deflecting a control operator, as in the Line Envelope 210. So a variation of Line Envelope 210 may be used to implement Reverse Continuation Sub-Envelope 440.

Control Operator 10-2 may be alternately deflected and released, with interval selections made in between. However, if the note is held after a Forward or Reverse Attack Latch is activated and Control Operator 10-2 is deflected or released again, a Forward or Reverse Continuation Latch is activated, and Forward or Reverse Continuation Data is synthesized. Note deselection may also be used to select interval data for a control rate signal and/or audio rate signal, or to activate a Continuation Latch. The interaction rate signal data synthesized by Reverse Continuation Sub-Envelope 440 is sent to Line Notes 170-1 and Line Control 180-1 for use in Phrase Synthesis 70.

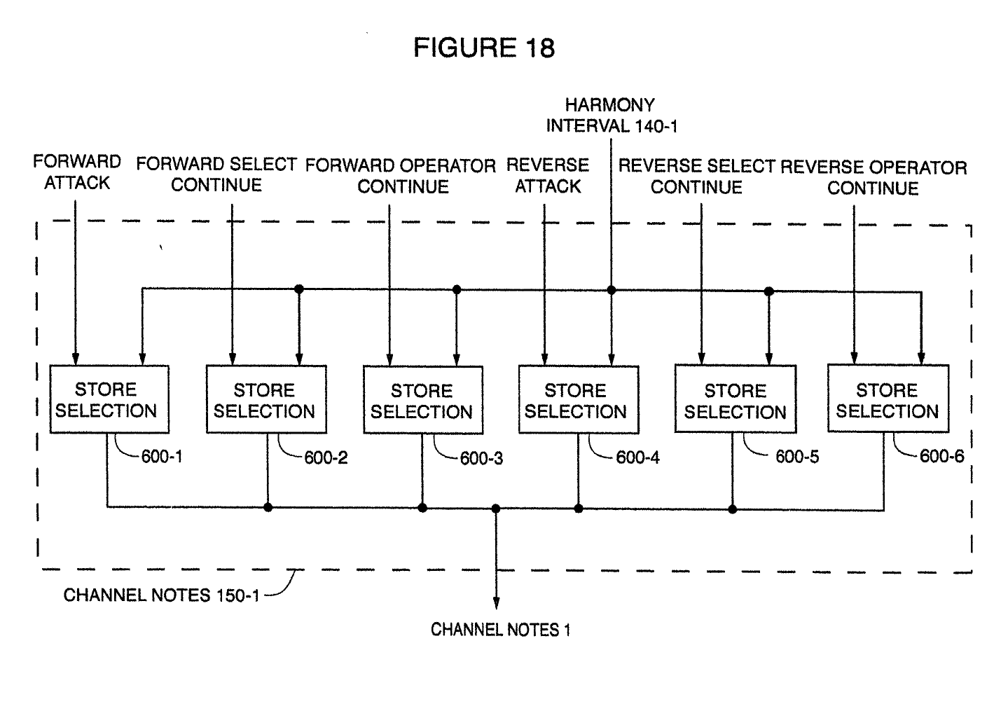

FIG. 18 shows an implementation for Channel Notes 150-1. Store Selection 600-1-2-3-4-5-6 store data to be used to activate audio rate signals. As depicted, they store pitch data, such as MIDI note numbers, from Harmony-Interval 140-1. Other data, such as MIDI velocity data or channelization data may be stored for use in activating an audio signal. Messages such as MIDI note-on data are generated by Channel Notes 150-1 and sent to Multichannel Audio Generator 80.

Only Six Store Selection functions are shown, although twelve inputs are depicted for Channel Notes 150-1. Those depicted input synthesized interaction rate signal data from Channel Envelope 100-1. Not depicted are Store Selection 600-7-8-9-10-11-12 for Channel Sub-Envelope 110-1-1. It will be appreciated that more could be employed, or as few as one. That is, envelope data may only be used to activate control rate signals that modulate a single audio signal per channel. As previously disclosed, physical modeling or other kinds of audio signal generators may be activated by continuous control rate signals, rather than by discrete data events. In such an embodiment, Channel Notes 150-1 isn't required. However two versions of Channel Control 160-1 may be provided, one for generation continuous control rate signals that activate audio signals, and one for generating continuous control rate signals that modulate activated audio signals. It will be appreciated that functions available for generating audio signals may generate audio signals that play once and stop. Or generated audio signals may loop for a period of time, or continuously until deactivation data is received.

Although there are only sixteen channels in the MIDI specification, various schemes have been devised by commercial manufacturers to allow a virtually unlimited number of channels to be synchronized. So the present invention could be implemented using conventional MIDI synthesizers. Alternatively, the present invention could be implemented in a proprietary system for which a matrix of audio signal generators are available. In the pictured embodiment, a twelve by four matrix would be appropriate—six audio signal generators for each channel of the Channel and Line Envelopes.

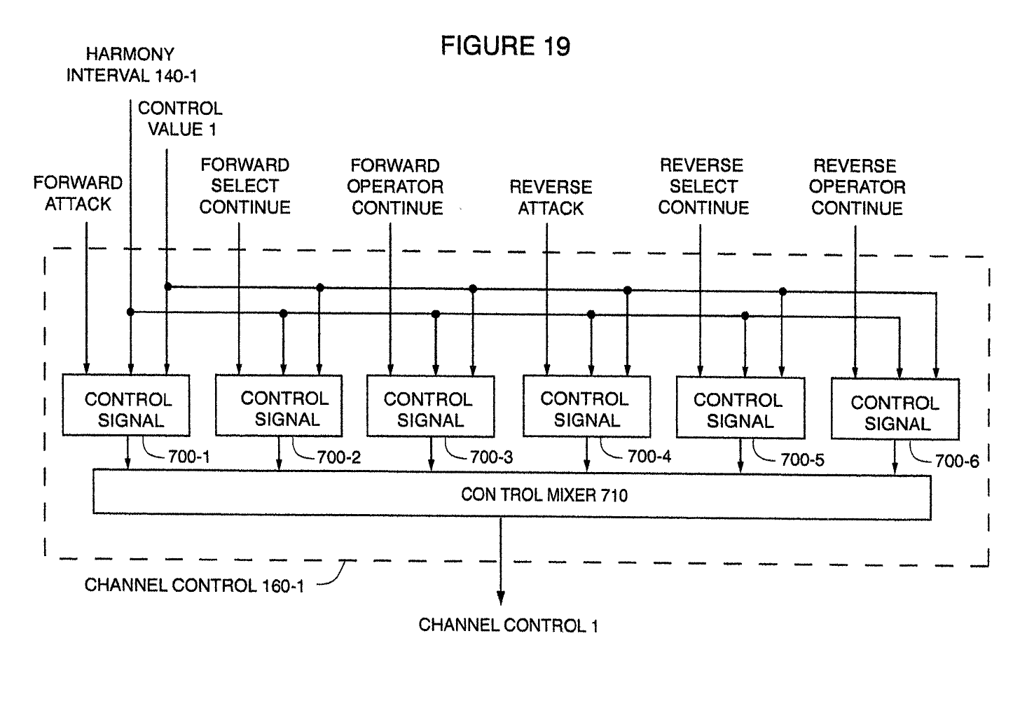

FIG. 19 shows an implementation for Channel Control 160-1. Control Signal 700-1-2-3-4-5-6 are used to generate continuous control rate signals. As depicted, they may use pitch data from Harmony-Interval 140-1, such as interval relationships calculated by subtracting subsequent MIDI note numbers. They may also use continuous data from Control Operator 10-1 to activate and modify control rate signals. Data output from 700-1-2-3-4-5-6 may include continuous control rate signals used to activate or modulate audio signals, and may also include discrete data used to activate or modulate audio signals.

Continuous control rate data from Control Value 40 may be used directly as control rate signals, or as index values for tables containing gesture simulation data. Data output by the tables may be used directly, or interpolated and further processed. Control rate data from Control Value 40 may also be used directly as modulation data for control rate signals generated by Control Value 40, as in the gesture synthesis methods previously disclosed in the referenced U.S. Pat. No. 6,066,794 and pending Reissue patent application Ser. No. 09/594,741.

It will be appreciated that continuous audio or control rate signals may include repeating functions such as simulated trills or vibrato. Activated control rate signals may also include a series of line segments that play automatically from one point to the next, with parameters determined by note selections and/or control operator activation. When activated by synthesized interaction rate signal data from Channel Envelope 100-1 or Channel Sub-Envelope 120-1-1, Control Gesture 700-1-2-3-4-5-6 create channelized messages such as MIDI controller data, that are merged and sent to Multichannel Audio Generator 80.

Only Six Control Signal functions are shown, although twelve inputs are depicted for Channel Control 160-1. Those depicted receive inputs from Channel Envelope 100-1. Not depicted are Control Signal 700-7-8-9-10-11-12 for Channel Sub-Envelope 110-1-1. It will be appreciated that more could be employed, or none. In this case all interactive control envelope data may be used to activate audio signals.

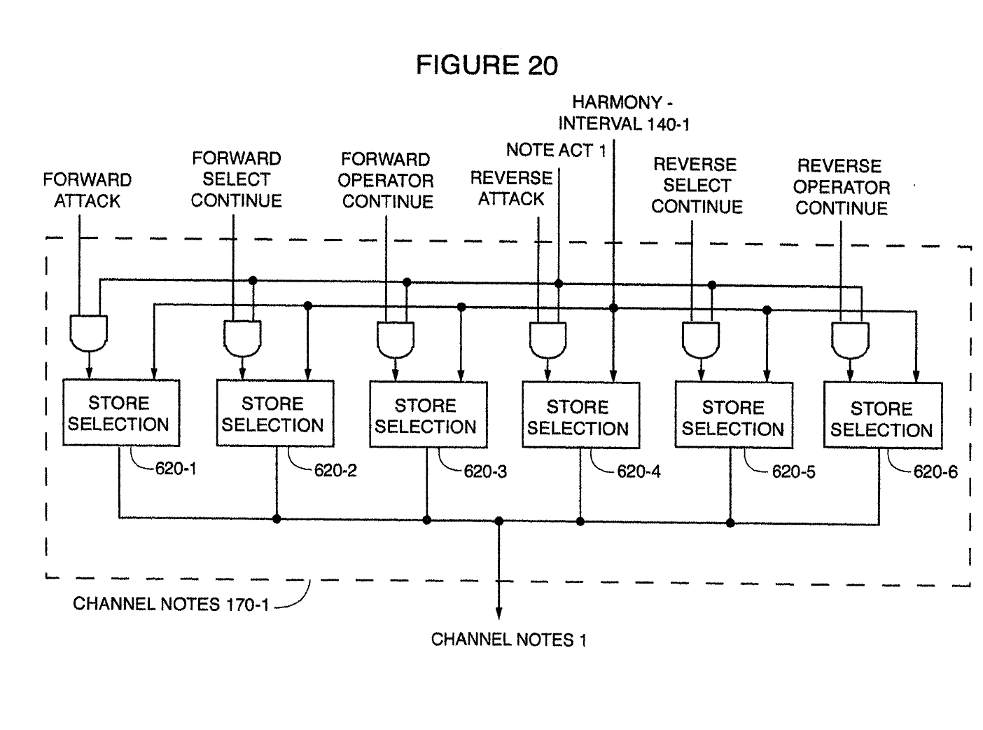

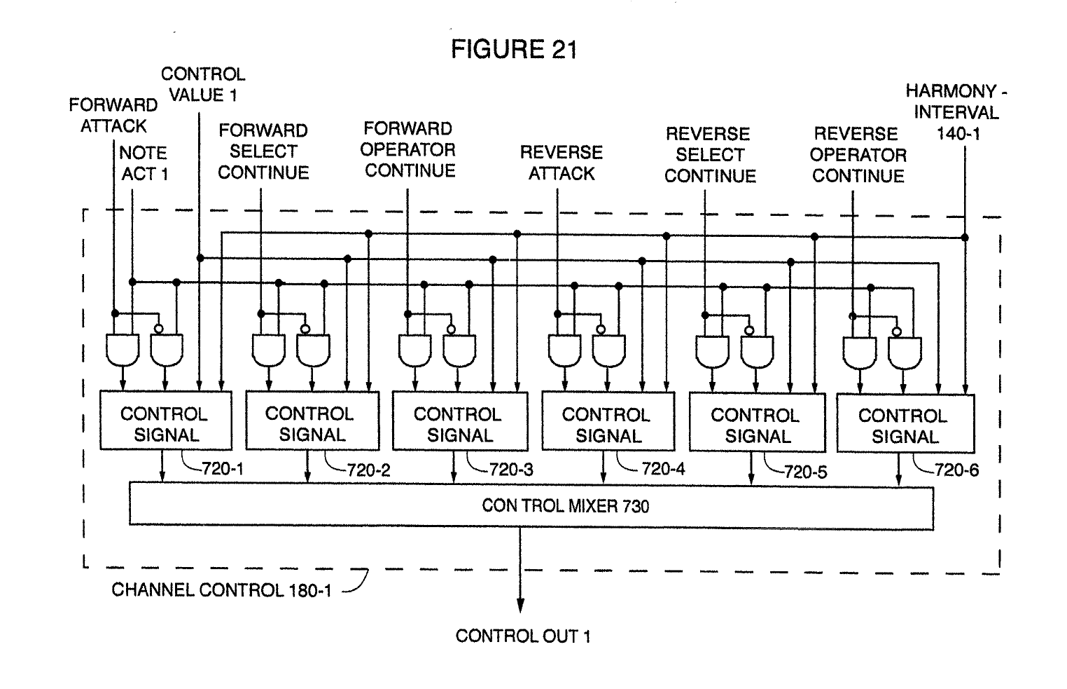

FIGS. 20 and 21 depict Line Notes 170-1 and Line Control 180-1. These are very much the same as Channel Notes 150-1 and Channel Control 160-1. The only depicted difference is that since a single Line Envelope 110 and Line Sub-Envelope 130-1 are used to activated all four channels, a means of determining which channels are active is necessary, to avoid sending spurious data to MultiChannel Audio Generator 80. Therefore, channelized Note Act data from Channel Note Select 60 is used to enable each component of Line Notes 170-1 and Line Control 180-1. In another embodiment, a separate Line Envelope and Line Sub-Envelope may be required for each channel. In this case, Line Notes 170-1 and Line Control 180-1 may be identical in function to Line Notes 150-1 and Line Notes 160-1.

It will be appreciated that other similar performance modes to those disclosed above may be implemented. For example, some of the disclosed Continuation Latch circuits may be replaced with Sub-Envelopes. In an alternative embodiment of the Line Envelope 110, selecting a note activates the note, then deflecting a control operator activates an Attack Latch and latches on the note. The note and the envelope is latched off by releasing the operator, deselecting the note, and then deflecting the operator again. The other side of this envelope could be activated by first deflecting the operator, then selecting the note. The note is latched on until the operator is released, the note is deselected, and the operator deflected again.

Channel Sub-Envelope 120-1-1, not previously described in detail, includes a Forward Attack Latch activated when an operator is deflected, after selection by Forward Attack Data from Channel Envelope 110-1. The Channel Sub-Envelope 120-1-1 Reverse Attack Latch is activated by an operator release, after being selected by the Reverse Attack Data from Channel Envelope 100-1. In another embodiment, Channel Sub-Envelope 120-1-1 Forward Attack Latch may be selected by deflection of one operator, and then activated by deflection of a second operator, before the first is released.

An interactive control envelope may be implemented using a Forward Attack Latch that is selected by a note selection, and activated by a second note selection, before the first is deselected. Continuation Data may be synthesized by additional note selections and/or deselections. The Forward Attack Latch may be deactivated by selecting the same note twice. In this embodiment, the second deslection may activate a Damp Latch. Alternatively, the Forward Attack Latch may be deactivated by deselecting all notes, then deflecting a control operator. In this case, the operator release may activate a Damp Latch.

A Reverse Attack Latch for the “Fingered Control Envelope” described above, may be selected by a first note selection, then activated by deselection of the selected note. So selection activates a note and deselection latches it on. Additional New Note/Same Note data including note deselections may be usefull for this implementation.

In an alternative embodiment to the above, the first note selection may not activate a note, but only select the Forward Attack Latch. A second note selection activates the Forward Attack Latch, which also activates and latches on an audio rate and/or control rate signal.

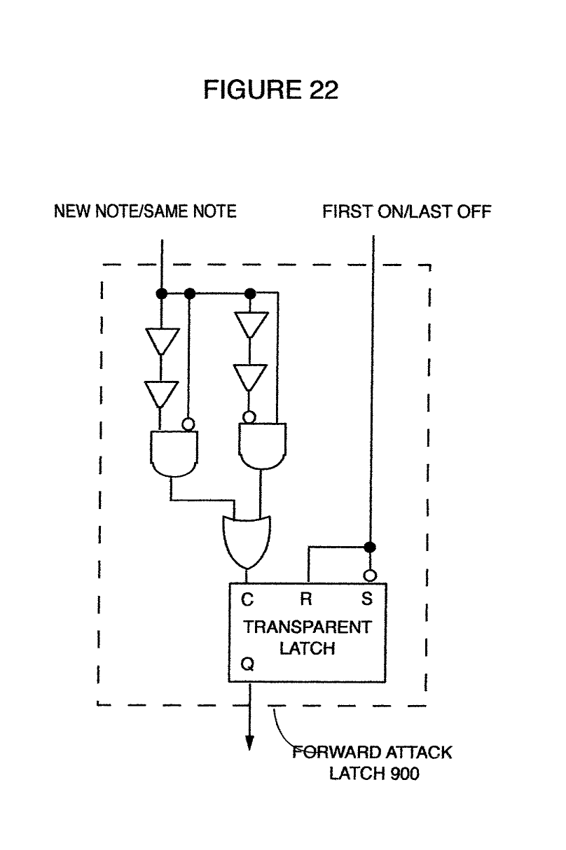

An embodiment for a Forward Attack Latch that can be used to implement a Fingered Control Envelope is shown in FIG. 22, Forward Attack Latch 900. It will be appreciated that Forward Attack Latch 900 may also be implemented using a circuit similar to those for the previously specified envelopes. Or a code module similar to those previously disclosed can be used to implement Forward Attack Latch 900.

In still another embodiment, similar to a performance mode embodied by a fingered control envelope as described above, a note may be selected and activated to select a Forward Attack Latch. Then the Forward Attack Latch is activated by deflection of a control operator. If the note is deselected before activating a control operator, the Attack Latch is deselected. Once the Attack Latch is activated, releasing the operator and/or selecting additional notes may then activate Continuation Latches.

In another variation of a Fingered Control Envelope, a first note selection activates a note and selects a Forward Attack Latch. Then a second note selection occurring before the first is deselected, activates the Forward Attack Latch, but doesn't activate a control rate or audio rate signal. A subsequent operator deflection activates a signal that traverses the interval between the two selected notes. Additional selections and control operator deflections may be made at will to synthesize Continuation Data.

It will be appreciated that the kinds of variations disclosed above for a Fingered Control Envelope may also be applied to the disclosed Channel and Line Mode Envelopes and Sub-Envelopes, to create a variety of alternative performance modes. For example, an interesting performance mode could be implemented by substituting deflection of control operators for note selections in a Fingered Control Envelope, to implement an “Operator Control Envelope”. Deflection of one operator activates a note and also selects a Forward Attack Latch. Deflection of a second operator activates the Forward Attack Latch. Telease of the first operator could activate a Reverse Attack Latch. Subsequent operator deflections synthesize Continuation Data that may activate control rate data that simulates portamento pitch glides. This embodiment is similar to the Channel Sub-Envelope 110-1-1. Although there has been no selection for a discrete position with a note selection device, deflecting the first operator activate a predetermined audio rate signal.

The above is similar to how a very expressive one-stringed bowed Chinese instrument, called a Zheng, works. Melodies are played by gliding one note to another along a fretboard. In the above embodiment for an operator Control Envelope, four or more control operators could each select initial starting pitches and also activate a simulated bowing gesture. Each operator also selects a separate Forward and/or Reverse Attack Latch, which when activated, each selects a separate set of Continuation Latches, that may be activated by each of the other operators, and so on. Thus a large number of possible pathways for performing attack and continuation gestures, only by deflecting operators, could be provided. Additional interaction rate event data, New Operator/Same Operator and First Deflected/Last Released, could be usefull for such an embodiment. Thus additional data generated by Logic Data 40, labeled D′ and D″ is shown in FIG. 2.

It will further be appreciated that the disclosed Envelopes and Sub-Envelopes may be used to control duration of audio signals. For example, a performance mode may be implemented so that each note is activated before the previous is deactivated, according to synthesized interaction rate signals. This creates a kind of “legato”.

A phrase may be created with a single held note, once activated and latched on by a biasing gesture, by using interaction rate signals mapped to tone parameters, to make subtle variations. More than one interactive control envelope may be used simultaneously, one to control amplitude, one to control pitch, and one more to control some aspect of timbre, for example. In one or more interactive control envelopes, note deselections may perform the same function as note selections in others, allowing for alternating and overlapping effects. Likewise operator deflection and operator release may activate alternating interaction rate signal data via different interactive control envelopes controlling different aspects of the sound.

The disclosed interactive control envelopes, or modifications of them, may also be used to activate and deactivate layered audio signals, so that variations in harmonization and orchestration may be introduced, which may themselves form the Attack and Continuation segments of a phrase. These kinds of variations may include doubling of tones, expansion, transposition or inversion or chords, or addition of ornaments or other features derived from input selections, under control of synthesized interaction rate signals.

The element of time may also be introduced. For example, sending a logical True followed by a logical False at interaction rate could be used as a time window. This is the equivalent of generating an interaction rate clock pulse. Other possible performance modes implemented using interactive control envelopes, selected and activated by sequences of user actions may be recognized by those skilled in the art.

### SUMMARY AND CONCLUSION

The present invention provides an Interactive Performance Interface for an electronic audio system, that includes at least one performance mode. Within each performance mode, a musicianuser can create phrases by selecting and activating a variety of control rate and audio rate signals, according to interaction rate signals synthesized by interactive control envelopes. Performance modes, envelopes, control rate signals and audio signals are selected and activated using a limited number of user controls, which change function according to a hierarchy of conditional latches.

The above description should not be construed as limiting the scope of the invention. Those skilled in the art will recognize other embodiments and combinations of elements. The invention itself may be embodied in a variety of physical constructions, including, but not limited to, an outboard accessory for use with music synthesizers, or a stand alone controller that includes hardware operators, for use with tone modules or computer music systems. It may also be implemented as a software upgrade for existing synthesizers, or as personal computer based synthesis software. Or the disclosed system may be integrated into an all-in-one music workstation. The interface layer itself may be built into a computer chip, or other electronic device, or may be stored on magnetic, optical, or other machine readable memory storage medium for use in a host system.

It will further be appreciated that the present invention is not limited to the manipulation of musical data as set forth in the MIDI specification. Other data protocols representing audio parameters, as described in the present invention, may be utilized. Or non-musical data may be manipulated as here described, and used within an audio system. In general, modifications and variations may be made to the disclosed embodiments without departing from the subject and spirit of the invention as defined by the following claims.

What is claimed is:

1. An interactive performance interface for use with an electronic audio system that generates at least one audio signal, said interactive performance interface coupleable to at least a first user-input control device, and including at least one performance mode comprising;
first detection means, coupled to said first user-input control device, for generating interaction rate event data representing user operation of said first user-input control device,
at least a first interactive control envelope means for synthesizing an interaction rate signal representative of a phrase, at least initiated by said audio signal,
said first interactive control envelope means synthesizing said interaction rate signal responsive to said interaction rate event data, such that the generated said audio signal at least initiates a phrase responsive to and modifiable by said first user-input device.

2. The interactive performance interface of claim 1 that has at least one characteristic selected from a group consisting of, (i) said first detection means inputs MIDI compatible data, (ii) said interaction rate event data is MIDI compatible at least in part, (iii) said interaction rate signal is MIDI compatible at least in part, (iv) said electronic audio system is MIDI compatible.

3. The interactive performance interface of claim 1, wherein said interactive control interface is implemented in at least one device selected from a group consisting of (i) a stand-alone musical instrument, (ii) a stand-alone electromechanical device, (iii) a machine-readable storage device for use with a host system, (iv) a magnetic storage medium for use with a host system, and (v) an optical storage medium for use with a host system.

4. The interactive performance interface of claim 1, wherein said interaction rate event data includes at least one logic data selected from a group consisting of (i) logic data representing user operation of a control operator, (ii) selection data representing user selections of notes of a note selection device, (iii) first on/last off data, (iv) new note/same note data, (v) first deflected/last released data, and (vi) new operator/same operator data.

5. The interactive performance interface of claim 1, wherein said interactive control envelope means includes at least one attack latch for synthesizing attack data, selected from a group consisting of (i) a forward attack latch, and (ii) a reverse attack latch.

6. The interactive performance interface of claim 5, wherein said interactive control envelope means further includes at least one latch selected from a group consisting of (i) a continuation latch to synthesize continuation data, and (ii) a damp latch to synthesize damping data.

7. The interactive performance interface of claim 1, wherein said interactive control envelope means for synthesizing an interaction rate signal is selected from a group consisting of (i) a channel envelope, (ii) a line envelope, (iii) a fingered control envelope, and (iv) an operator control envelope.

8. The interactive performance interface of claim 7 wherein said performance mode further includes at least one interactive control envelope means for synthesizing an interaction rate signal, selected from a group consisting of (i) a channel sub-envelope, (ii) a line sub-envelope, (iii) a reverse continuation sub-envelope.

9. The interactive performance interface of claim 1, further including a harmony-interval means for generating at least one harmony-interval data selected from a group consisting of (i) harmonization data, (ii) interval data, (iii) deselection interval data.

10. The interactive performance interface of claim 1, further including at least one control rate signal generation means for generating at least one control rate signal responsive to said interaction rate signal, such that said audio signal provided by said electronic audio system is responsive to said control rate signal, said control rate signal generation means selected from a group consisting of (i) channel control, (ii) line control.

11. The interactive performance interface of claim 1, further including at least one note activation means for generating note activation data responsive to said interaction rate signal, such that said audio signal provided by said electronic audio system is activated by said note activation data, said at least one note activation means for generating note activation data selected from a group consisting of (i) channel notes, and (ii) line notes.

12. A method for providing at least one performance mode of an interactive performance interface for an electronic audio system, comprising the steps of:
(a) generating interaction rate event data responsive to operation of at least a first user-input device,
(b) synthesizing an interaction rate signal responsive to said interaction rate event data,
(c) activating at least one audio signal responsive to at least said first user-input device, said audio signal at least initiating a phrase represented by said interaction rate signal.

13. The method of claim 12 wherein at least one of steps (a), (b), and (c) are MIDI compatible.

14. The method of claim 12, wherein at least two of steps (a), (b), and (c) are carried out in a device selected from a group consisting of (i) a stand-alone musical instrument, (ii) a stand-alone electromechanical device, (iii) a computer system that reads memory whereon is stored a routine that when executed by said computer system executes at least said two steps.

15. The method of claim 12, at step (a) said interaction rate event data includes at least one logic data selected from a group consisting of (i) logic data representing user operation of a control operator, (ii) selection data representing user selections of notes of a note selection device, (iii) first on/last off data, (iv) new note/same note data, (v) first deflected/last released data, and (vi) new operator/same operator data.

16. The method of claim 12, wherein step (b) further includes selecting an interactive control envelope.

17. The method claim 16, wherein step (b) further includes selecting an interactive control envelope from a group consisting of, (i) a channel envelope, (ii) a line envelope, (iii) a fingered control envelope, and (iv) an operator control envelope.

18. The method of claim 17, further including selecting an interactive control envelope from a group consisting of, (i) a channel sub-envelope, (ii) a line sub-envelope, and (iii) a reverse continuation sub-envelope.

19. The method of claim 12, wherein step (c) further includes at least one step selected from a group consisting of (i) synthesizing forward attack data, and (ii) synthesizing reverse attack data.

20. The method of claim 19, wherein step (c) further inclues at least one step selected from a group consisting of (i) synthesizing continuation data, and (ii) synthesizing damping data.

21. The method of claim 12, further including generating at least one harmony-interval data selected from a group consisting of, (i) harmonization data, (ii) interval data, (iii) interval deselection data.

22. The method of claim 12, further including activating control rate data responsive to said interaction rate signal, such that said phrase is responsive to and modifiable by said control rate data.

23. A method of synthesizing a phrase responsive to user operation of at least one user-input device comprising the steps of:
(a) generating interaction rate event data responsive to operation of at least a first user-input device,
(b) selecting an interactive control envelope contained in a performance mode,
(c) synthesizing an interaction rate signal,
(d) activating at least one audio signal responsive to at least said first user-input device, said audio signal at least initiating a phrase represented by said interaction rate signal.

24. A computer readable medium whereon is stored a routine that upon execution by a computer system will perform the following steps:
(a) generating interaction rate event data responsive to operation of at least a first user-input device;
(b) synthesizing an interaction rate signal responsive to said interaction rate event data; and
(c) activating at least one audio signal responsive to at least said first user-input device, said audio signal at least represented by said interaction rate signal.

25. The medium of claim 24, wherein said medium is selected from a group consisting of (i) magnetic storage, and (ii) optical storage.

26. A computer readable medium whereon is stored a routine that upon execution by a computer system will perform the following steps:
(a) generating interaction rate event data responsive to operation of at least a first user-input device;
(b) selecting an interactive control envelope contained in a performance mode;
(c) synthesizing an interaction rate signal; and
(d) activating at least one audio signal responsive to at least said first user-input device, said audio signal at least initiating a phrase represented by said interaction rate signal.

27. The medium of claim 26, wherein said medium is selected from a group consisting of (i) magnetic storage, and (ii) optical storage.

28. An interactive performance interface for use with an electronic audio system that generates at least one audio signal, said interactive performance interface coupleable to at least a first user-input control device and including at least one performance mode, the interactive performance interface comprising:
a circuit detector, coupled to said first user-input control device, to generate interaction rate event data representing user operation of said first user-input control device;
at least a first interactive control envelope circuit that synthesizes an interaction rate signal representative of a phrase at least initiated by said audio signal;
said first interactive control envelope circuit synthesizing said interaction rate signal responsive to said interaction rate event data such that the generated said audio signal at least initiates a phrase responsive to and modifiable by said first user-input device.

29. An interactive performance interface as in claim 28 wherein said interaction rate event data includes at least one data selected from a group consisting of (i) logic data that represents user operation of a control operator, (ii) selection data that represents user selections of notes of a note selection device, (iii) first on/last off data, (iv) new note/same note data, (v) first deflected/last released data, and (vi) new operator/same operator data.

30. An interactive performance interface as in claim 28, wherein said interactive control envelope circuit includes at least one attack latch circuit selected from a group consisting of (i) a forward attack latch, and (ii) a reverse attack latch, said attack latch circuit synthesizing attack data responsive to said interaction rate event data.

31. An interactive performance interface as in claim 30, wherein said interactive control envelope circuit further includes at least one latch circuit selected from a group consisting of (i) a continuation latch that synthesizes continuation data responsive to said interaction rate event data, and (ii) a damp latch that synthesizes damping data responsive to said interaction rate event data.

32. An interactive performance interface as in claim 28, wherein said interactive control envelope circuit is selected from a group consisting of (i) a channel envelope, (ii) a line envelope, (iii) a fingered control envelope, and (iv) an operator control envelope.

33. An interactive performance interface as in claim 32 further including at least one interactive control envelope circuit that synthesizes an interaction rate signal, selected from a group consisting of (i) a channel sub-envelope, (ii) a line sub-envelope, (iii) a reverse continuation sub-envelope.
